(19) United States
(12) Patent Application Publication
(10) Pub. No.: US 2016/0005375 A1
(43) Pub. Date: Jan. 7, 2016

(54) ELECTROCHROMIC DISPLAY DEVICE, AND PRODUCING METHOD AND DRIVING METHOD THEREOF

(71) Applicants: Yoshihisa Naijo, Kanagawa (JP); Tohru Yashiro, Kanagawa (JP); Hiroyuki Takahashi, Kanagawa (JP); Koh Fujimura, Tokyo (JP); Shigenobu Hirano, Kanagawa (JP); Toshiya Sagisaka, Kanagawa (JP); Satoshi Yamamoto, Kanagawa (JP); Daisuke Goto, Kanagawa (JP); Keiichiroh Yutani, Kanagawa (JP); Yoshinori Okada, Kanagawa (JP); Kazuaki Tsuji, Kanagawa (JP); Sukchan Kim, Kanagawa (JP); Mamiko Inoue, Tokyo (JP); Keigo Takauji, Kanagawa (JP); Tamotsu Horiuchi, Shizuoka (JP)

(72) Inventors: Yoshihisa Naijo, Kanagawa (JP); Tohru Yashiro, Kanagawa (JP); Hiroyuki Takahashi, Kanagawa (JP); Koh Fujimura, Tokyo (JP); Shigenobu Hirano, Kanagawa (JP); Toshiya Sagisaka, Kanagawa (JP); Satoshi Yamamoto, Kanagawa (JP); Daisuke Goto, Kanagawa (JP); Keiichiroh Yutani, Kanagawa (JP); Yoshinori Okada, Kanagawa (JP); Kazuaki Tsuji, Kanagawa (JP); Sukchan Kim, Kanagawa (JP); Mamiko Inoue, Tokyo (JP); Keigo Takauji, Kanagawa (JP); Tamotsu Horiuchi, Shizuoka (JP)

(73) Assignee: RICOH COMPANY, LTD., Tokyo (JP)

(21) Appl. No.: 14/752,244

(22) Filed: Jun. 26, 2015

(30) Foreign Application Priority Data
Jul. 1, 2014 (JP) 2014-136084
Jan. 20, 2015 (JP) 2015-008760

(51) Int. Cl. G09G 3/38; G09G 3/16; G02F 1/155

(52) U.S. Cl. CPC G09G 3/38; G02F 1/155; G09G 3/16; G02F 2001/1555; G09G 2320/0204; G09G 2320/0219; G09G 2330/028

(57) ABSTRACT

An electrochromic display device is provided. The electrochromic display device includes a first substrate; a first electrode formed of a transparent conductive film, overlying the first substrate; a second electrode formed of a transparent conductive film, overlying the first electrode; a white reflective layer, overlying the second electrode; a reflective layer, overlying the white reflective layer; a support substrate, overlying the reflective layer; an electrochromic layer, adjacent to the first electrode or the second electrode; and an electrolyte, present between the first electrode and the second electrode.

### CROSS-REFERENCE TO RELATED APPLICATIONS

This patent application is based on and claims priority pursuant to 35 U.S.C. §119(a) to Japanese Patent Application No. 2014-136084 and 2015-008760, filed on Jul. 1, 2014 and Jan. 20, 2015, respectively, in the Japan Patent Office, the entire disclosure of which is hereby incorporated by reference herein.

### BACKGROUND

1. Technical Field

The present disclosure relates to an electrochromic display device, particularly for multicolor display, and a producing method and a driving method thereof.

2. Description of the Related Art

In recent years, there is a growing need for electronic paper as an electronic medium that replaces paper, and development of electronic paper is actively taking place. As means for realizing electronic paper display system, light emitting display technologies, such as liquid crystal display and organic electroluminescence (EL) display, have been developed, and some of them have been put into production. On the other hand, reflective display technologies that are low in power consumption and excellent in visibility are expected to become next-generation electronic paper display technologies.

As an example of reflective display technologies, reflective liquid crystal display technology using cholesteric liquid crystal has been proposed. Because of utilizing selective reflection and using a large number of substrates, however, reflective liquid crystal display technology is poor in reflectance, contrast, color saturation, and color reproduction. The visibility thereof is far from that of paper. As another example of reflective display technologies, electrochromic display technology has attracted attentions. Electrochromic display technology uses organic electrochromic materials that combine high color reproducibility and display memory performance.

Electrochromism is a phenomenon in which color reversibly changes as an oxidation-reduction reaction reversibly occurs upon application of a voltage. Electrochromic display device uses color development/discharge phenomena of electrochromic compounds that cause electrochromism. Being one type of reflective display devices, having display memory performance, and being drivable at low voltages, electrochromic display device is under research and development from broad perspectives, from material development to device design, as a strong candidate for electronic paper display technology.

Electrochromic display device is capable of developing various colors depending on the structures of electrochromic compounds and is expected as a multicolor display device. Electrochromic display device is one type of electrochemical elements that utilizes color reaction caused by oxidation-reduction reaction of active materials occurred at the surfaces of a pair of opposing electrodes upon application of a voltage between the electrodes. To realize vivid full-color display, a superposition structure of three subtractive primary colors of yellow, cyan, and magenta is necessary.

### SUMMARY

In accordance with some embodiments of the present invention, an electrochromic display device is provided. The electrochromic display device includes a first substrate; a first electrode formed of a transparent conductive film, overlying the first substrate; a second electrode formed of a transparent conductive film, overlying the first electrode; a white reflective layer, overlying the second electrode; a reflective layer, overlying the white reflective layer; a support substrate, overlying the reflective layer; an electrochromic layer, adjacent to the first electrode or the second electrode; and an electrolyte, present between the first electrode and the second electrode.

In accordance with some embodiments of the present invention, a method of producing an electrochromic display device is provided. The method includes the steps of

1) forming a flattening layer on a drive substrate, and forming a through hole;

2) forming a reflective layer serving as a mirror electrode on the flattening layer;

3) forming a white reflective layer on the reflective layer, forming a flattening film on the white reflective layer, and forming a through hole;

4) forming a pair of a second electrode, formed of a transparent film, and an optional electrochromic layer adjacent to the second electrode on the flattening film;

5) optionally forming a pair of a pixel electrode and an electrochromic layer adjacent to the pixel electrode between the second electrode and a first electrode, formed of a transparent film, via a porous insulating layer, and forming a through hole;

6) forming the first electrode on the pair of the second or pixel electrode and the electrochromic layer adjacent thereto via a porous insulating layer, or on a pair of a first substrate and an optional electrochromic layer adjacent to the first substrate;

7) dividing into pixels; and

8) sticking the drive substrate having the layers formed in the steps 1) to 6) thereon and the first substrate optionally having the layers formed in the step 6) thereon together while filling the layers disposed therebetween with an electrolyte.

In accordance with some embodiments of the present invention, a method of driving the above electrochromic display device is provided. When the support substrate is a drive substrate having drive circuits composing sub pixels, and at least one of the sub pixel is connected to a counter electrode composed of the first electrode or the second electrode via the reflective layer serving as a mirror electrode, and each of the other sub pixels is connected to one of display electrodes composed of the first electrode, the second electrode, or a pixel electrode via the reflective layer serving as a mirror electrode, the electrochromic display device is driven by applying a voltage to between the sub pixel connected to the counter electrode and at least one of the sub pixels connected to the display electrode.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIGS. 1A to 1D are schematic views of electrochromic display devices according to the first embodiment of the present invention;

FIGS. 2A to 2D are schematic views of electrochromic display devices according to the second embodiment of the present invention;

FIGS. 3A to 3H are schematic views of electrochromic display devices according to the third embodiment of the present invention;

FIGS. 4A to 4B are schematic views of electrochromic display devices according to the fourth embodiment of the present invention;

FIG. 5 is a scanning electron microscopic (SEM) image of a cross-section of an electrochromic display device according to the fifth embodiment of the present invention, including porous inorganic films formed by colloidal lithography;

FIG. 6 is a schematic view of an electrochromic display device according to the seventh embodiment of the present invention;

FIG. 7 is a schematic view of an electrochromic display device according to the eighth embodiment of the present invention:

FIG. 8 is a schematic view of a variation of the electrochromic display device according to the eighth embodiment of the present invention;

FIG. 9 is a schematic view of another variation of the electrochromic display device according to the eighth embodiment of the present invention;

FIG. 10 is a flowchart showing a method of producing an electrochromic display device according to some embodiments of the present invention;

FIG. 11 is a flowchart showing a method of producing an electrochromic display device according to the eighth embodiment of the present invention;

FIGS. 12A to 12F, 13A to 13G, and 14A to 14H are schematic views illustrating processes for producing electrochromic display devices according to the eighth embodiment of the present invention;

FIG. 15 shows reflectance spectra of the white reflective layers obtained in Example 1 and Comparative Example 1;

FIG. 16 shows reflectance spectra of the white reflective layers obtained in Example 2 and Comparative Example 2;

FIG. 17 is a schematic view of an electrochromic display device prepared in Comparative Example 3;

FIG. 18 shows reflectance response curves at 550 nm of the electrochromic display elements obtained in Example 2 and Comparative Example 3 upon application of rectangular voltage;

FIG. 19 is a plan view of pixels of an electrochromic display device prepared in Example 4 showing the positions of through holes;

FIG. 20 is a plan view of pixels of an electrochromic display device prepared in Example 5 showing the positions of through holes;

FIG. 21 is a schematic view of an electrochromic display device prepared in Comparative Example 4;

FIG. 22 is a schematic view of an electrochromic display device prepared in Comparative Example 5; and

FIG. 23 is an image of an electrochromic display device prepared in Example 3 developing color.

### DETAILED DESCRIPTION

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

For the sake of simplicity, the same reference number will be given to identical constituent elements such as parts and materials having the same functions and redundant descriptions thereof omitted unless otherwise stated.

Within the context of the present disclosure, if a first layer is stated to be “overlaid” on, or “overlying” a second layer, the first layer may be in direct contact with a portion or all of the second layer, or there may be one or more intervening layers between the first and second layer, with the second layer being closer to the first substrate than the first layer.

If a first layer is stated to be “adjacent” to a second layer, the first layer is in direct contact with a portion or all of the second layer.

One object of the present invention is to provide an electrochromic display device for full-color display providing excellent responsiveness and resolution while preventing the occurrence of color blur between pixels.

Various techniques haven been proposed to obtain an electrochromic display device for full-color display. However, these techniques have problems in, for example, full-color display aperture ratio, crosstalk between multiple display electrodes, display image retention performance, color diffusion (color blur) between pixels caused because the pixels are electrically connected by a display electrode in an electrochromic layer in the same display electrode, and difficulty in control depending on the displayed image.

The inventors of the present invention have found that these problems can be solved by an electrochromic display device including first and second electrodes each formed of a transparent conductive film, a white reflective layer, a support substrate, an electrochromic layer adjacent to the first or second electrode, and an electrolyte, and further including a reflective layer (preferably a metal having a high reflectance) between the white reflective layer and the support substrate (drive substrate).

Accordingly, these problems can be solved by an electrochromic display device including: a first substrate; a first electrode formed of a transparent conductive film, overlying the first substrate; a second electrode formed of a transparent conductive film, overlying the first electrode; a white reflective layer, overlying the second electrode; a reflective layer, overlying the white reflective layer; a support substrate, overlying the reflective layer; an electrochromic layer, adjacent to the first electrode or the second electrode; and an electrolyte, present between the first electrode and the second electrode.

In accordance with some embodiments of the present invention, an electrochromic display device for full-color display providing excellent responsiveness and resolution while preventing the occurrence of color blur between pixels is provided.

In accordance with an embodiment of the present invention, the electrochromic display device includes: a first substrate; a first electrode formed of a transparent conductive film, overlying the first substrate; a second electrode formed of a transparent conductive film, overlying the first electrode; a white reflective layer, overlying the second electrode; a reflective layer, overlying the white reflective layer; a support substrate, overlying the reflective layer; an electrochromic layer, adjacent to the first electrode or the second electrode; and an electrolyte, present between the first electrode and the second electrode.

In the electrochromic display device according to an embodiment of the present invention, since the reflective layer (preferably a metal having a high reflectance) is disposed between the white reflective layer and the support substrate, the white reflective layer can be thinned as much as possible. In addition, no white reflective layer is disposed between the electrodes formed of transparent conductive films (i.e., between the effective electrodes including the first and second electrodes and any electrode disposed between the first and second electrodes). Thus, a full-color electrochromic display device which provides excellent responsiveness and resolution while preventing the occurrence of color blur between pixels can be provided.

Full-color display is achieved by superimposing three subtractive primary colors of yellow, cyan, and magenta, as described above. In the electrochromic display device according to an embodiment of the present invention, multiple electrochromic layers each developing different colors are stacked, and each electrochromic layer is electronically connected to a drive circuit in a drive substrate (applicable to both active matrix substrates and passive matrix substrates) to achieve full-color display.

The reflective layer may be composed of a metal having a high reflectance or an alloy thereof, an amorphous alloy, a microcrystalline alloy, or a stacked film thereof. The reflective layer can be used as a mirror electrode because of having conductivity. As the reflective layer combines the mirror electrode, the reflective layer may be hereinafter referred to as the mirror electrode.

In the present disclosure, one of the first and second electrodes is a display electrode and the other is a counter electrode. Hereinafter, the display electrode may be referred to as a pixel electrode. Hereinafter, the support substrate may be referred to as a second substrate.

The electrochromic display device according to an embodiment of the present invention is applicable to both active matrix and passive matrix. In addition, because a metal electrode having a resistivity lower than that of ITO can be used as wiring (i.e., drawn around under the white reflective layer), the influence of voltage drop can be drastically reduced. In the case of a reflective display element, it is also applicable to segment display. Reducing the resistivity of ITO results in a larger thickness as well as poorer transmittance. This is more drastic in the case of a large display element.

The electrochromic display device in accordance with some embodiments of the present invention is described in detail below with reference to the drawings.

### First Embodiment

In accordance with a first embodiment of the present invention, the electrochromic display device includes: a first substrate; a first electrode formed of a transparent conductive film, overlying the first substrate; a second electrode formed of a transparent conductive film, overlying the first electrode; a white reflective layer, overlying the second electrode; a reflective layer, overlying the white reflective layer; a support substrate, overlying the reflective layer; an electrochromic layer, adjacent to the first electrode or the second electrode; and an electrolyte, present between the first electrode and the second electrode.

The following description is based on a case where the support substrate is a drive substrate having a thin-film transistor (TFT) drive circuit. The electrochromic display device is not limited to the below-described configurations. As an alternative configuration, for example, each of the first electrode, the second electrode, and the reflective layer may be divided, with the second electrode being divided so as to orthogonally intersect with the first electrode or into pixels, and the first electrode and the reflective layer orthogonally intersecting with each other so as to form a matrix.

As described above, the electrochromic display device according to some embodiments of the present invention is applicable to both active matrix and passive matrix. In the case of using a drive substrate, an electrochromic element for excellent full-color display can be provided by use of a single drive substrate.

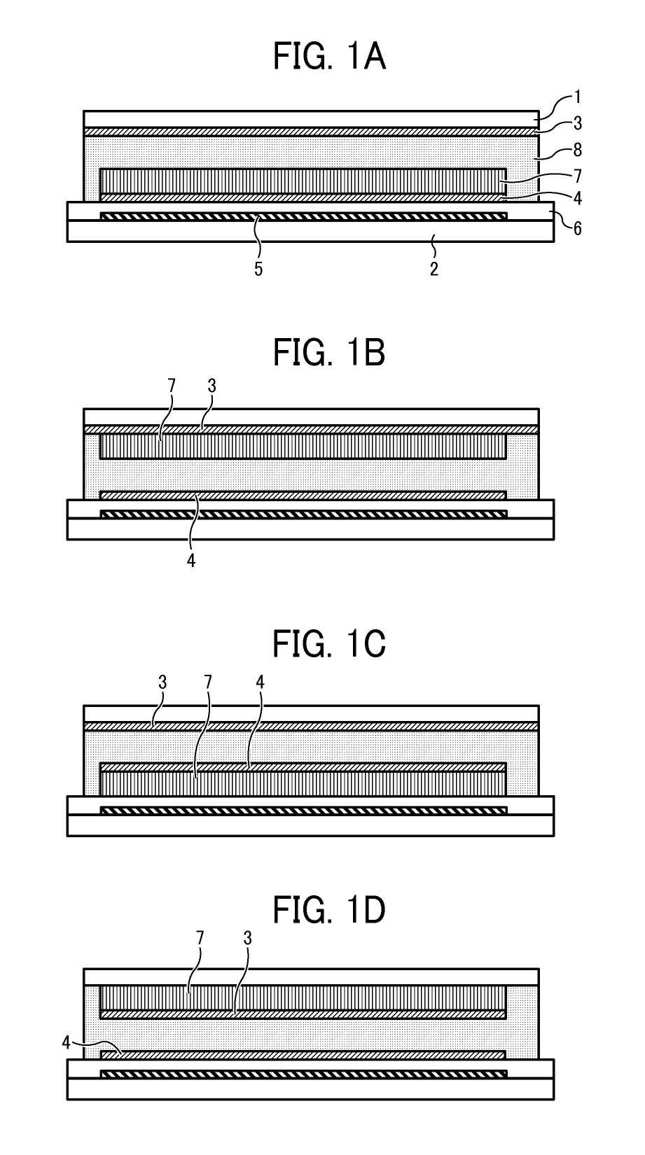

FIGS. 1A to 1D are schematic views of electrochromic display devices according to the first embodiment of the present invention.

In FIG. 1A, a numeral 1 denotes a first substrate, a numeral 2 denotes a drive substrate, a numeral 3 denotes a first electrode (transparent conductive film), a numeral 4 denotes a second electrode (transparent conductive film), a numeral 5 denotes a reflective layer, a numeral 6 denotes a white reflective layer, a numeral 7 denotes an electrochromic layer, and a numeral 8 denotes an electrolyte.

As described above, one of the first and second electrodes is a display electrode and the other is a counter electrode. In FIG. 1A, the first electrode is a counter electrode and the second electrode is a display electrode.

Typical reflective display elements generally display white color by back scattering of environmental light. To sufficiently gain back scattering, the white reflective layer needs to be relatively thick. For example, when using rutile-type titanium oxide particles having a particle diameter of about 250 nm, widely used as white pigments, the white reflective layer needs to have a thickness of 10 μm or more to sufficiently gain back scattering, depending on the difference in refractive index between the particles and the environment. If the thickness falls below 10 μm, forward scattering becomes dominant to cause light loss, resulting in a low reflectance.

In the present embodiment, the reflective layer 5 disposed between the white reflective layer 6 and the drive substrate 2 reflects forward scattering to suppress light loss. Since the reflective layer 5 is composed of a metallic material, the reflective layer 5 can also be utilized as an electrode (a mirror electrode).

In addition, since the white reflective layer is not formed between the second electrode (e.g., display electrode) and the first electrode (e.g., counter electrode), the gap between the electrodes can be narrowed as much as possible. As a result, an electric field within the display element is suppressed from spreading in an in-plane direction, providing excellent resolution.

In a case where a white reflective layer is formed of a thick porous body and is located between the second electrode (e.g., display electrode) and the first electrode (e.g., counter electrode), ions are blocked from moving, which is disadvantageous in terms of responsiveness. By contrast, the electrochromic display device according to an embodiment of the present embodiment is free from such a disadvantage and provides excellent responsiveness.

FIGS. 1B to 1D are variations of the electrochromic display device according to the first embodiment.

In FIGS. 1B and 1D, the first electrode is a display electrode and the second electrode is a counter electrode.

In FIG. 1C, the first electrode is a counter electrode and the second electrode is a display electrode, as is the case with FIG. 1A.

In FIGS. 1C and 1D, the first or second electrode formed of a transparent conductive film (formed of an inorganic film) should be a porous film. The reason is described later.

### Second Embodiment

In accordance with a second embodiment of the present invention, the electrochromic display device further includes a flattening film between the second electrode and the white reflective layer.

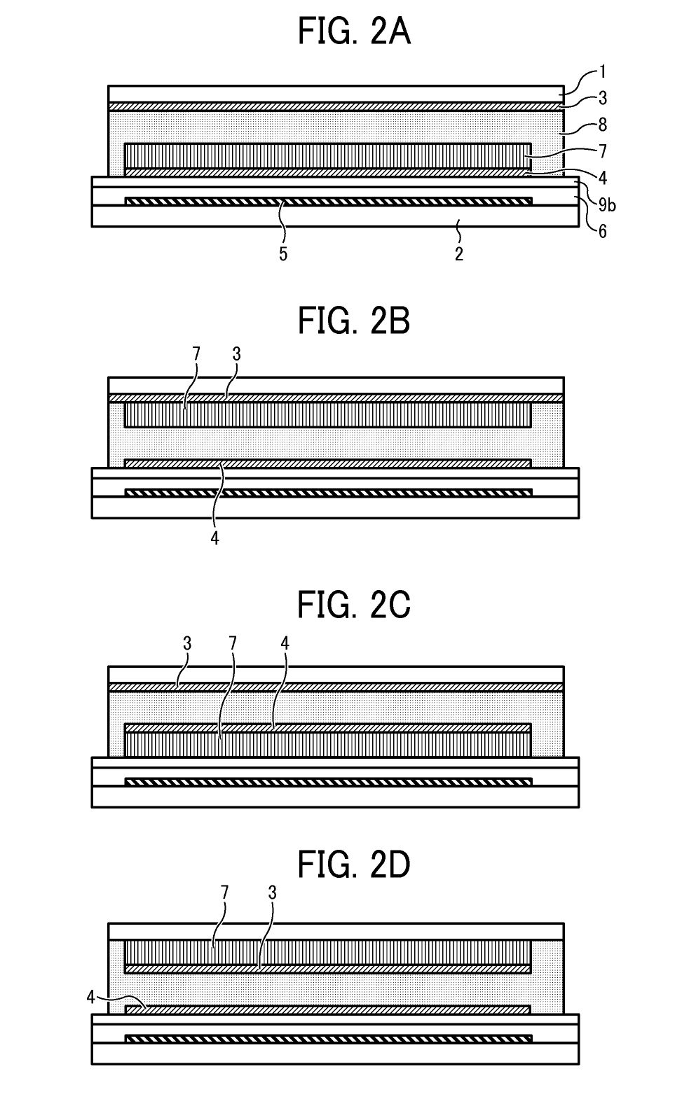

Referring to FIGS. 2A-2D, a flattening film 9b is provided on the white reflective layer 6.

When the white reflective layer has large surface irregularities, the apparent distance of the transparent conductive film provided on the white reflective layer, serving as the second electrode, is extended to increase the resistance, which is disadvantageous in terms of conductivity. By providing the flattening film on the white reflective layer to increase flatness, the transparent conductive film becomes excellent in conductivity. The transparent conductive film can be formed by various methods. When the transparent conductive film is directly formed by means of sputter film formation on an organic film, there may be a problem that the organic film is undesirably colored. This problem can be avoided by providing a protective layer on the flattening film.

### Third Embodiment

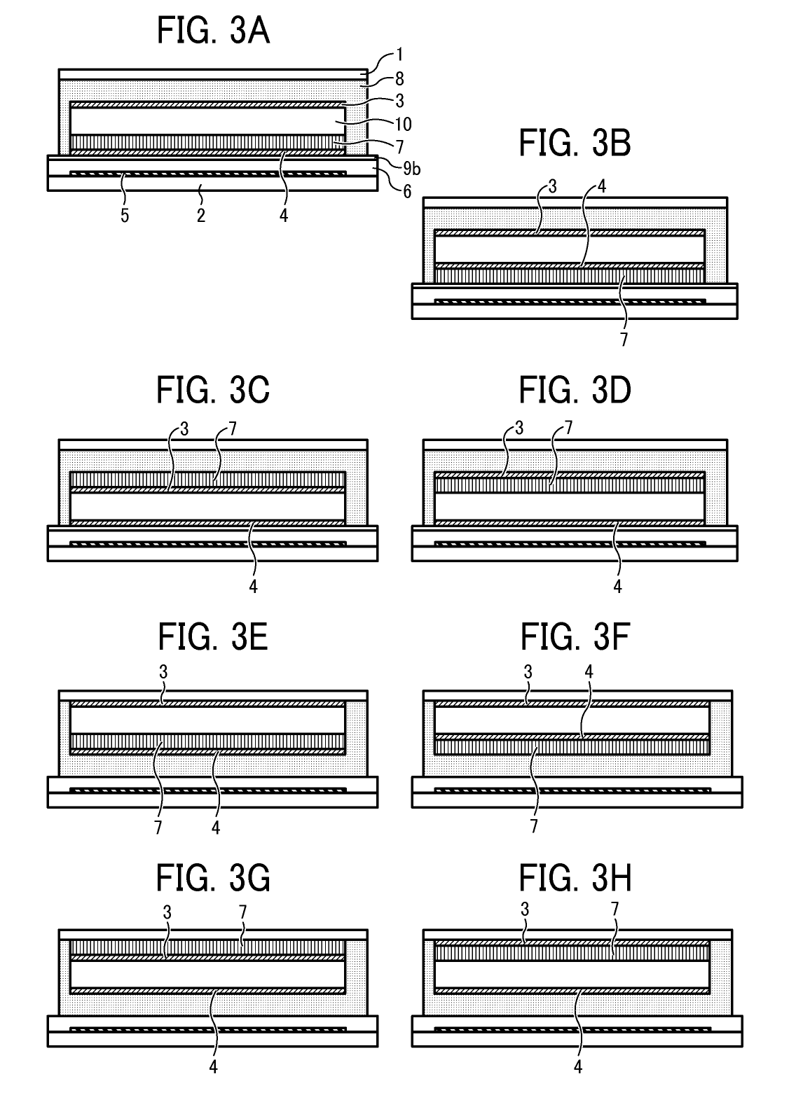

In accordance with a third embodiment of the present invention, the electrochromic display device further includes a porous insulating layer between the first electrode and the second electrode. FIGS. 3A to 3H are schematic views of electrochromic display devices according to the third embodiment of the present invention.

In FIG. 3A, a numeral 1 denotes a first substrate, a numeral 2 denotes a drive substrate, a numeral 3 denotes a first electrode (transparent conductive film), a numeral 4 denotes a second electrode (transparent conductive film), a numeral 5 denotes a reflective layer, a numeral 6 denotes a white reflective layer, a numeral 7 denotes an electrochromic layer, a numeral 8 denotes an electrolyte, a numeral 9b denotes a flattening film, and a numeral 10 denotes a porous insulating layer.

In FIG. 3A, the first electrode is a counter electrode and the second electrode is a display electrode.

According to FIG. 3A, owing to the provision of the porous insulating layer, the distance between the first and second electrodes can be kept constant regardless of whether warpage of the substrates has been caused upon sticking of the substrates together to seal the electrochromic display device. Thus, uniform responsiveness is provided in a plane.

In FIGS. 3A to 3D, all the functional films are formed on one of the substrates, i.e., the drive substrate. In these cases, a protective layer formed of a resin or the like can substitute for the first substrate, providing a simpler element configuration.

FIGS. 3B to 3H are variations of the electrochromic display device according to the third embodiment. In some of these variations, the inorganic films composing the electrochromic display device should be a porous film. The reason is described later.

In FIGS. 3B, 3E, and 3F, the first electrode is a counter electrode and the second electrode is a display electrode.

In FIGS. 3C, 3D, 3G, and 3H, the first electrode is a display electrode and the second electrode is a counter electrode.

### Fourth Embodiment

In accordance with a fourth embodiment of the present invention, the electrochromic display device further includes one or more pairs of a pixel electrode formed of a transparent conductive film and an electrochromic layer adjacent to the pixel electrode, stacked between the first electrode and the second electrode via an insulating layer.

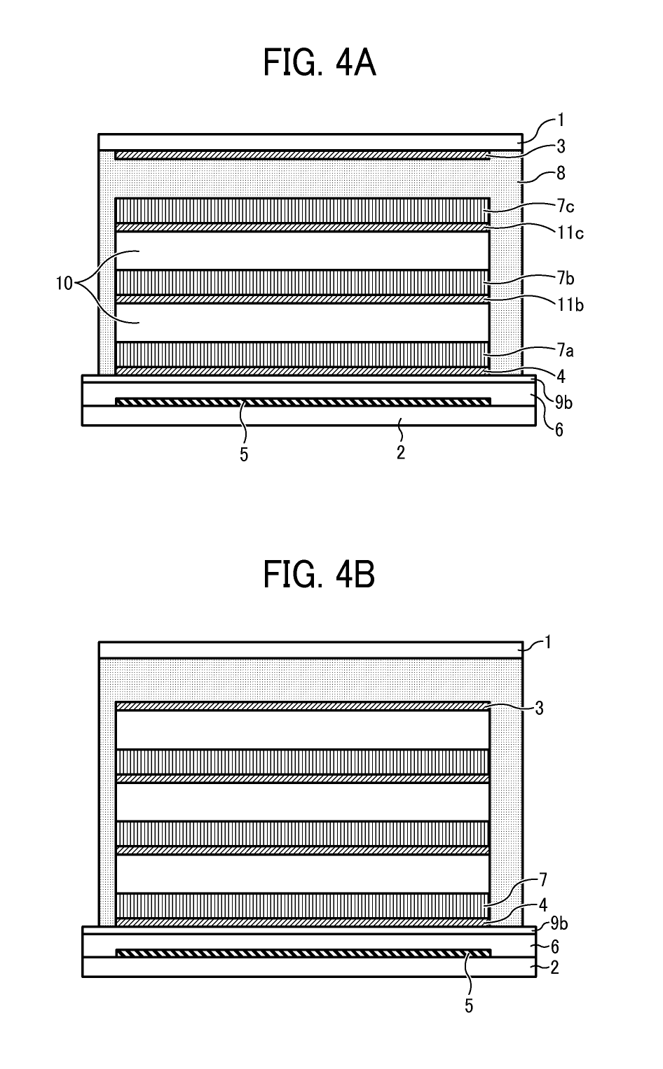

FIGS. 4A and 4B are schematic views of electrochromic display devices according to the fourth embodiment of the present invention.

In FIG. 4A, a numeral 1 denotes a first substrate, a numeral 2 denotes a drive substrate, a numeral 3 denotes a first electrode (transparent conductive film), a numeral 4 denotes a second electrode (transparent conductive film), a numeral 5 denotes a reflective layer, a numeral 6 denotes a white reflective layer, a numeral 7a denotes a first electrochromic layer, a numeral 7b denotes a second electrochromic layer, a numeral 7c denotes a third electrochromic layer, a numeral 8 denotes an electrolyte, a numeral 9b denotes a flattening film, a numeral 10 denotes a porous insulating layer, a numeral 11b denotes a pixel electrode II (display electrode II), and a numeral 11c denotes a pixel electrode III (display electrode III).

In FIGS. 4A and 4B, the first electrode 3 is a counter electrode, and each of the second electrode 4, pixel electrode 11b, pixel electrode 11c is a display electrode.

According to the fourth embodiment, the electrochromic display device includes multiple electrochromic layers. When each of the electrochromic layers includes an electrochromic material developing a different color, it is possible to develop multiple colors based on the principle of subtractive color mixing. By stacking the subtractive primary colors of magenta, yellow, and cyan, full-color development can be achieved.

### Fifth Embodiment

In accordance with a fifth embodiment of the present invention, all films disposed between the first electrode or the electrochromic layer, whichever is closest to the first substrate, and the second electrode or the electrochromic layer, whichever is closest to the support substrate, including the transparent conductive films forming the first and second electrodes, are each formed of a porous film having ion-permeable through holes.

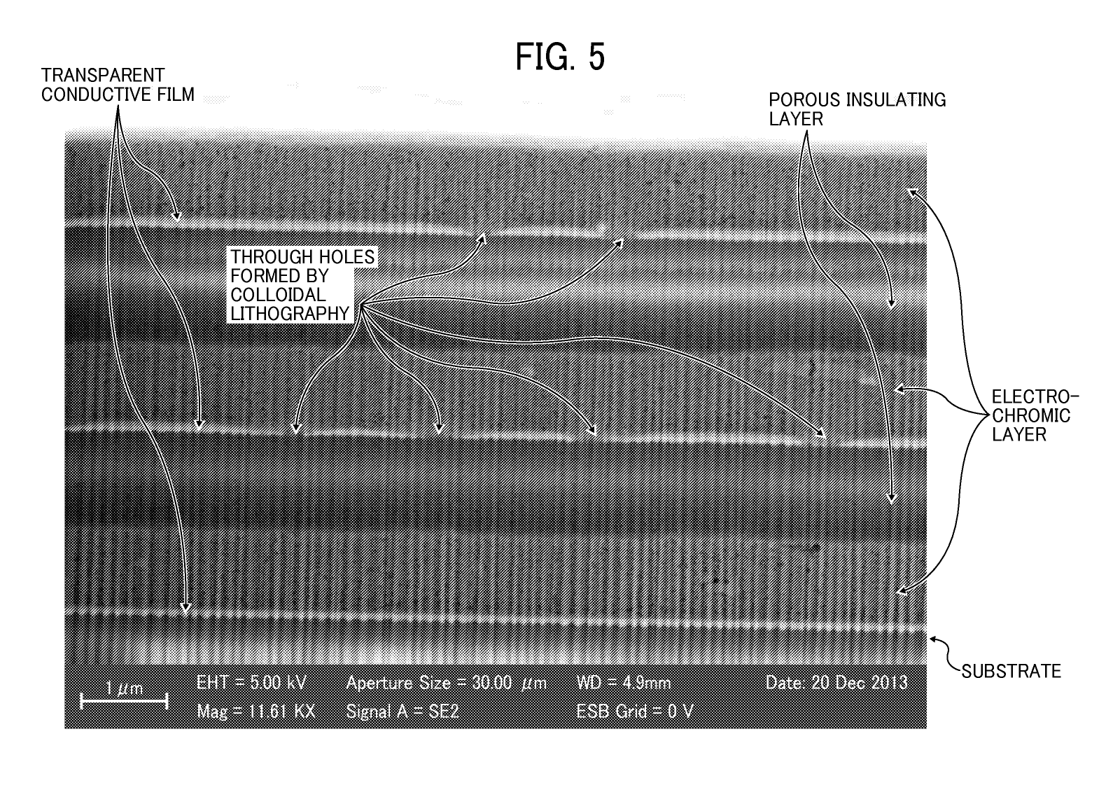

FIG. 5 is a scanning electron microscopic (SEM) image of a cross-section of the electrochromic display device according to the fifth embodiment of the present invention, including porous inorganic films formed by colloidal lithography.

As all the inorganic films (including the electrodes described in the above-described embodiments) are formed of a porous film having ion-permeable through holes, it is possible to cause an electrochemical reaction in all the electrochromic layers. In particular, an inorganic film formed by vacuum film formation is a dense film with poor ion-permeability. When such an inorganic film is stacked, ions are blocked from moving and it is impossible to cause an electrochemical reaction.

One specific method of forming inorganic porous films includes a colloidal lithography as described in JP-2013-210581-A, the disclosure of which is incorporated herein by reference.

### Sixth Embodiment

In accordance with a sixth embodiment of the present invention, the electrochromic layer includes a porous electrode formed of a transparent conductive film having ion-permeable fine through holes and electrochromic molecules modifying a surface of the porous electrode.

The porous electrode has a wide specific surface area. Even when the porous electrode is in the form of a thin film having a thickness of approximately 1 μm, the surface thereof can be modified with sufficient amount of electrochromic molecules. Thus, excellent responsiveness and contrast can be provided.

### Seventh Embodiment

In accordance with a seventh embodiment of the present invention, the electrochromic display device includes a first electrochromic layer adjacent to the first electrode and a second electrochromic layer adjacent to the second electrode. The first electrochromic layer develops a color upon an oxidation-reduction reaction, and the second electrode develops a complementary color of the color developed in the first electrochromic layer upon a reverse reaction of the oxidation-reduction reaction.

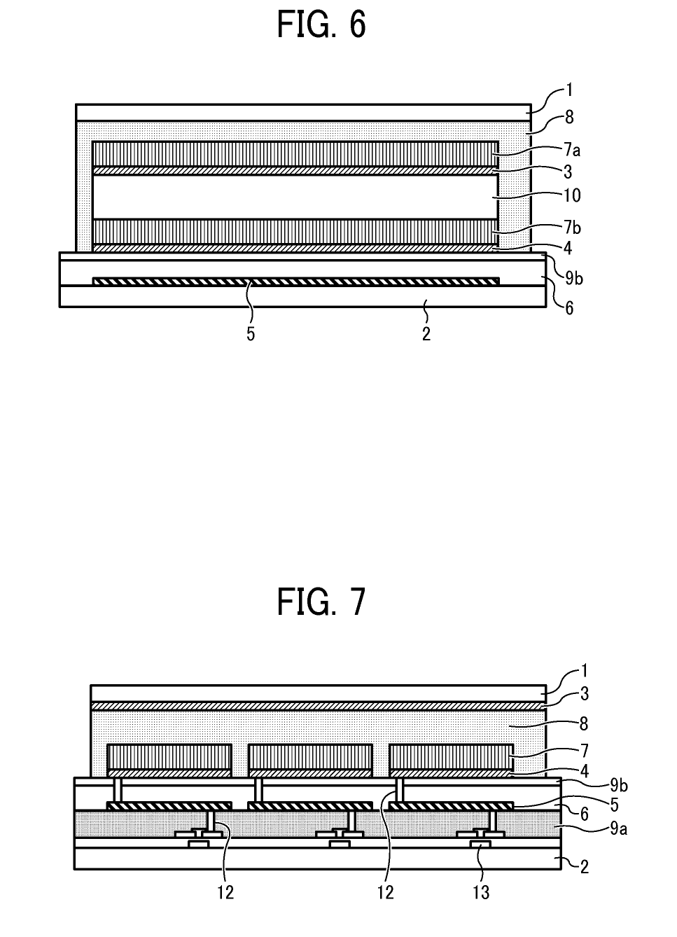

FIG. 6 is a schematic view of an electrochromic display device according to the seventh embodiment of the present invention.

In FIG. 6, a numeral 1 denotes a first substrate, a numeral 2 denotes a drive substrate, a numeral 3 denotes a first electrode (transparent conductive film), a numeral 4 denotes a second electrode (transparent conductive film), a numeral 5 denotes a reflective layer, a numeral 6 denotes a white reflective layer, a numeral 7a denotes a first electrochromic layer, a numeral 7b denotes a second electrochromic layer, a numeral 8 denotes an electrolyte, a numeral 9b denotes a flattening film, and a numeral 10 denotes a porous insulating layer.

According to the seventh embodiment, when the first electrochromic layer includes an electrochromic molecule developing color upon a reduction reaction, the second electrochromic layer includes an electrochromic molecule developing color upon an oxidation reaction.

In electrochemical reactions, generally, a reverse reaction occurs at the counter electrode of a working electrode. Accordingly, in the seventh embodiment, it is possible to develop colors simultaneously in both the first and second electrochromic layers by a single drive operation. As a result, high-contrast colors can be developed. In addition, since the second electrochromic layer develops the complementary color of a color developed in the first electrochromic layer, it is possible to develop black color relatively easily.

### Eighth Embodiment

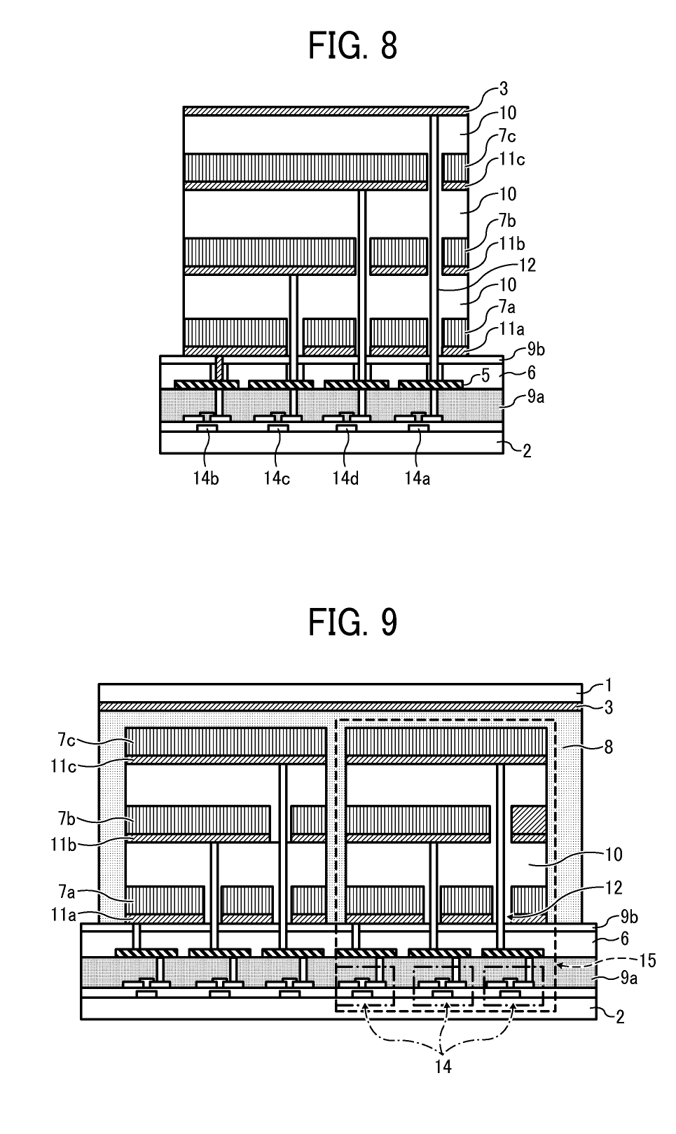

In accordance with an eighth embodiment of the present invention, the first electrode or the second electrode is composed of pixel electrodes arranged in a matrix, and each pair of the pixel electrode and the electrochromic layer adjacent to the pixel electrode is set apart. FIG. 7 is a schematic view of an electrochromic display device according to the eighth embodiment of the present invention.

In FIG. 7, a numeral 1 denotes a first substrate, a numeral 2 denotes a drive substrate, a numeral 3 denotes a first electrode (transparent conductive film), a numeral 4 denotes a second electrode (transparent conductive film), a numeral 5 denotes a reflective layer (mirror electrode), a numeral 6 denotes a white reflective layer, a numeral 7 denotes an electrochromic layer, a numeral 8 denotes an electrolyte, a numeral 9a denotes a flattening layer, a numeral 9b denotes a flattening film, a numeral 12 denotes a through hole, and a numeral 13 denotes a thin film transistor (hereinafter “TFT”) that is a drive circuit.

In FIG. 7, the first electrode is a counter electrode and the second electrode is a display electrode.

In FIG. 7, an active matrix TFT using a thin film transistor (TFT) is employed as the drive substrate. In other words, the TFT is provided on the support substrate. The electrochromic display device with such a configuration can provide dot matrix display.

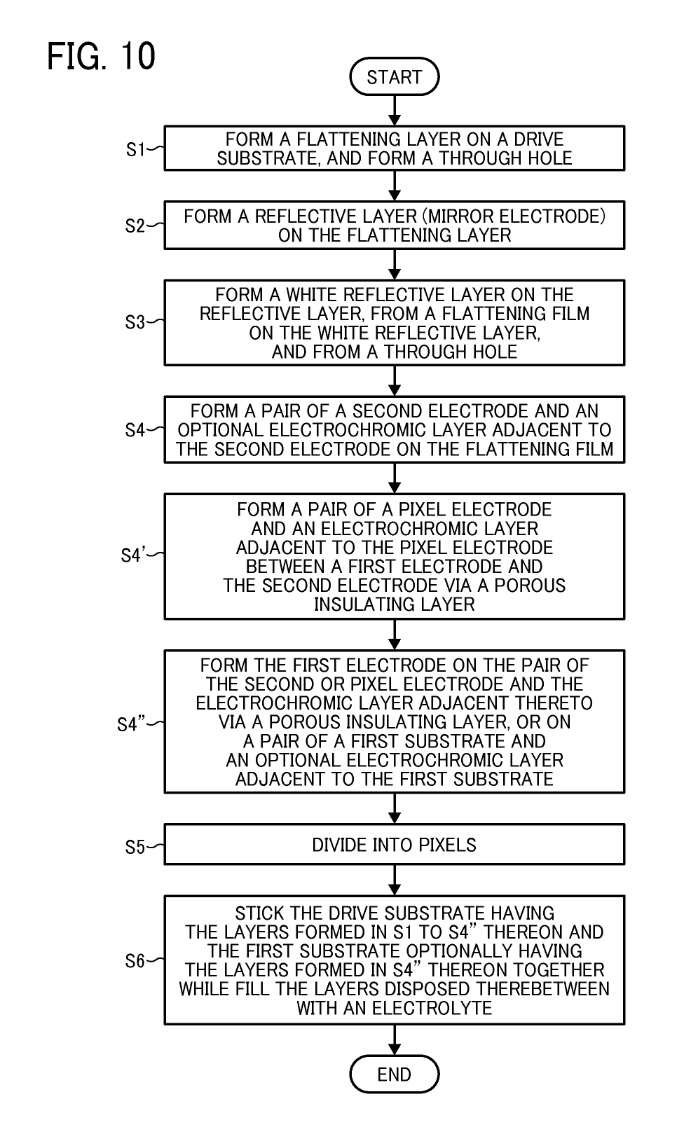

FIG. 8 is a schematic view of a variation of the electrochromic display device according to the eighth embodiment of the present invention. In FIG. 8, multiple pairs of an electrode formed of a transparent conductive film and an electrochromic layer adjacent to the electrode are stacked between the first electrode and the second electrode via an insulating layer.

In FIG. 8, a numeral 3 denotes a first electrode (transparent conductive film), a numeral 7a denotes a first electrochromic layer I, a numeral 7b denotes a second electrochromic layer II, a numeral 7c denotes a third electrochromic layer III, a numeral 11a denotes a pixel electrode I (second electrode), a numeral 11b denotes a pixel electrode II, a numeral 11c denotes a pixel electrode III, a numeral 14a denotes a first sub pixel, a numeral 14b denotes a second sub pixel, a numeral 14c denotes a third sub pixel, and a numeral 14d denotes a fourth sub pixel.

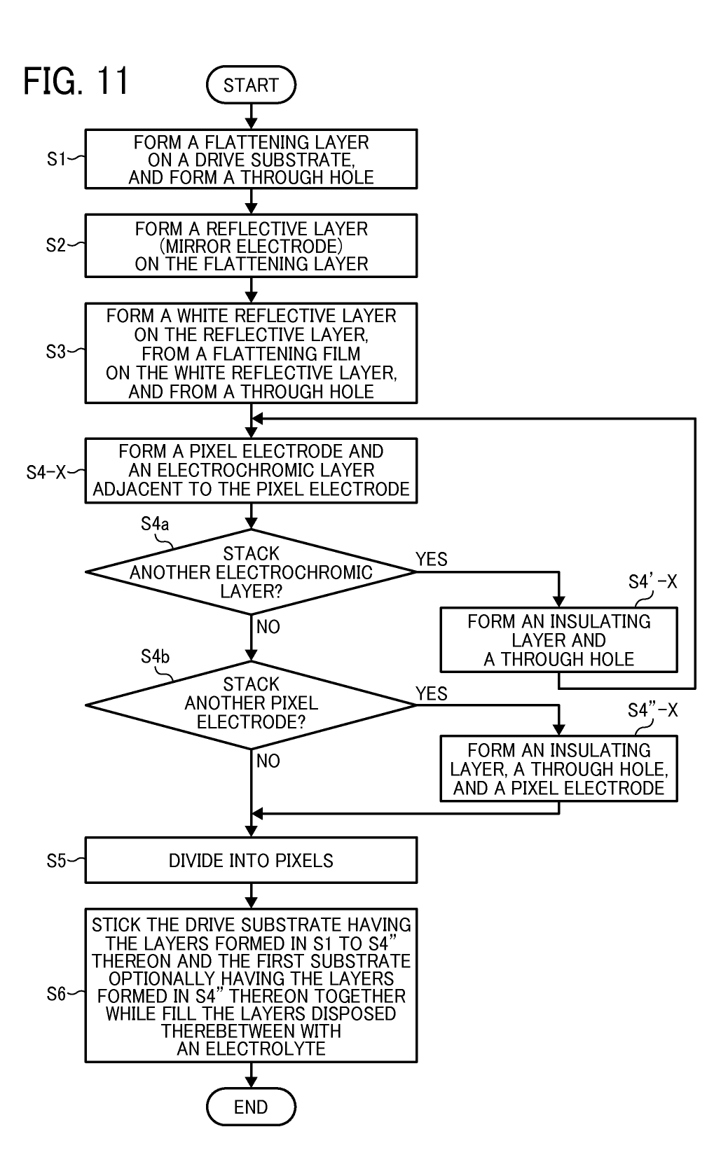

FIG. 9 is a schematic view of another variation of the electrochromic display device according to the eighth embodiment of the present invention. In FIG. 9, multiple pairs of an electrode formed of a transparent conductive film and an electrochromic layer adjacent to the pixel electrode are stacked between the first electrode and the second electrode via an insulating layer, as is the case with FIG. 8.

In FIG. 9, a numeral 1 denotes a first substrate, a numeral 2 denotes a drive substrate, a numeral 3 denotes a first electrode (transparent conductive film), a numeral 6 denotes a white reflective layer, a numeral 7a denotes a first electrochromic layer I, a numeral 7b denotes a second electrochromic layer II, a numeral 7c denotes a third electrochromic layer III, a numeral 8 denotes an electrolyte, a numeral 9a denotes a flattening layer, a numeral 9b denotes a flattening film, a numeral 10 denotes a porous insulating layer, a numeral 11a denotes a pixel electrode I (second electrode), a numeral 11b denotes a pixel electrode II, a numeral 11c denotes a pixel electrode III, a numeral 12 denotes a through hole, a numeral 14 denotes a sub pixel, and a numeral 15 denotes a pixel.

Each constitutional layer in the electrochromic display device is described in detail below.

### Reflective Layer

The reflective layer may be composed of a metal having a high reflectance or an alloy thereof, an amorphous alloy, a microcrystalline alloy, or a stacked film thereof.

Specific examples of the metal having a high reflectance include, but are not limited to, silver, aluminum, molybdenum, tungsten, nickel, chromium, and alloys thereof. Because silver is a metal having the highest reflectance in the visible light range, an alloy of silver, palladium, and copper (hereinafter “APC”) is preferably used.

The reflective layer can be formed by vacuum vapor deposition method, sputtering method, ion plating method, or the like method. In the case where the reflective layer material is coatable, the following methods can also be employed: spin coating method, casting method, micro gravure coating method, gravure coating method, bar coating method, roll coating method, wire bar coating method, dip coating method, slit coating method, capillary coating method, spray coating method, nozzle coating method, and various printing methods, such as gravure printing method, screen printing method, flexo printing method, offset printing method, reverse printing method, and inkjet printing method.

The reflective layer preferably has a thickness not less than 50 nm and less than 200 nm, and more preferably not less than 100 nm and less than 200 nm. In particular, an APC film formed in vacuum by sputtering method is preferred because of having improved environmental resistance and heat resistance while maintaining high reflectance and conductivity that are feature of silver.

The reflective layer can be used as a mirror electrode because of having conductivity.

### Support Substrate

Specific examples of the support substrate include, but are not limited to, a transparent substrate such as a glass substrate and a plastic film, an opaque substrate such as a silicon substrate and a metal substrate (e.g., stainless-steel substrate), and a stacked layer of these substrates.

Preferably, the support substrate is a drive substrate having a thin-film transistor (TFT) drive circuit. The drive circuit requires pixels be arranged in a matrix, and both passive and active matrix devices for use in dot matrix display can be used therefor. In particular, an active matrix TFT using a TFT (thin film transistor) is preferable.

The active matrix TFT may have an active layer including a silicon semiconductor such as amorphous silicon and polysilicon, an oxide semiconductor such as indium-gallium-zinc oxide (IGZO), a carbon semiconductor such as graphene and carbon nanotube, and/or an organic semiconductor such as pentacene. In particular, low-temperature polysilicon TFT and IGZO TFT, having relatively high mobility, are preferable.

In the drive circuit, each pixel preferably has multiple sub pixels, as shown in FIGS. 8 and 9. With respect to typical liquid crystal panels or organic electroluminescence (EL) panels, each pixel has three or four sub pixels. Sub pixels of three primary colors of red, green, and blue are arranged in a plane and independently controlled to achieve full-color display. Similarly, each pixel preferably has multiple sub pixels, as shown in a dotted-line square in FIG. 9.

### Transparent Conductive Film

The transparent conductive film, used for the first electrode, second electrode, and one or more electrodes disposed between the first electrode and the second electrode, is not limited to any particular material so long as it has transparency and conductivity.

As described above, one of the first and second electrodes is a display electrode and the other is a counter electrode.

### Display Electrode

The display electrode (pixel electrode) is preferably composed of a metal oxide such as indium oxide, zinc oxide, tin oxide, indium-tin oxide, and indium-zinc oxide. In addition, a network electrode of silver, gold, carbon nanotube, metal oxide, and the like, having transparency, and a composite layer thereof can also be used.

The display electrode can be formed by vacuum vapor deposition method, sputtering method, ion plating method, or the like method. In the case where the display electrode material is coatable, the following methods can also be employed: spin coating method, casting method, micro gravure coating method, gravure coating method, bar coating method, roll coating method, wire bar coating method, dip coating method, slit coating method, capillary coating method, spray coating method, nozzle coating method, and various printing methods, such as gravure printing method, screen printing method, flexo printing method, offset printing method, reverse printing method, and inkjet printing method.

The display electrode (pixel electrode) preferably has a transmittance not less than 60% and less than 100%, and more preferably not less than 90% and less than 100%. In particular, an indium-tin oxide (ITO) film formed in vacuum by sputtering method is preferred because of having excellent conductivity and transparency.

The transparent conductive film preferably has fine pores (fine through holes) for accelerating permeation of the electrolyte (electrolyte ions). Because conductive films formed by sputtering method, such as ITO film, generally have poor ion permeability, it is preferable that fine through holes are formed thereon for accelerating permeation of electrolyte ions.

Fine through holes can be formed by known methods.

Specific methods include the following, but are not limited thereto.

(1) Forming a foundation layer having irregularity before forming a display electrode, and forming a display electrode having the irregularity.
(2) Forming a convex-shaped structural body, such as micro pillar, before forming a display electrode, and removing the convex-shaped structural body after forming the display electrode.
(3) Spreading a foamable high-molecular polymer before forming a display electrode, and letting the polymer foam upon heating or degassing after forming the display electrode.
(4) Directly irradiating a display electrode with radiation to form fine holes.

Fine through holes provided to display electrodes (pixel electrodes) which are disposed between the first electrode (e.g., display electrode) closest to the first substrate (display substrate) and the second electrode (e.g., counter electrode) preferably have a hole diameter in the range of 0.01 to 100 μm. When the hole diameter is less than 0.01 μm, ion permeability is poor. When the hole diameter is in excess of 100 μm, the through holes are visually observable, which adversely affects display performance in the portions immediately above the fine through holes. To completely avoid such problems, the through holes preferably have a hole diameter in the range of 0.1 to 5 μm.

The ratio of the hole area of the fine through holes to the surface area of the display electrode (i.e., the hole density) is preferably in the range of 0.01% to 40%. When the hole density is too large, the holes are connected to each other, thereby degrading the display electrode in conductivity. In other words, defective display is caused due to what is called the percolation effect. When the hole density is too small, electrolyte ion permeability is so poor that a problem may arise in color development/discharge display.

### Counter Electrode

The counter electrode serving as the first electrode or the second electrode is not limited to any particular material so long as it has conductivity. The counter electrode is preferably composed of a metal oxide such as indium oxide, zinc oxide, tin oxide, indium-tin oxide, and indium-zinc oxide; a metal such as zinc and platinum; carbon; or a composite film thereof. To prevent the counter electrode from being irreversibly corroded by oxidation-reduction reactions, a protective layer can be formed so as to cover the counter electrode.

The counter electrode can be formed by vacuum vapor deposition method, sputtering method, ion plating method, or the like method. In the case where the counter electrode material is coatable, the following methods can also be employed: spin coating method, casting method, micro gravure coating method, gravure coating method, bar coating method, roll coating method, wire bar coating method, dip coating method, slit coating method, capillary coating method, spray coating method, nozzle coating method, and various printing methods, such as gravure printing method, screen printing method, flexo printing method, offset printing method, reverse printing method, and inkjet printing method.

### Protective Layer for Covering Counter Electrode

The protective layer for covering the counter electrode is not limited to any particular material so long as it prevents the counter electrode from being irreversibly corroded by oxidation-reduction reactions. Specific examples of materials for use in the protective layer include, but are not limited to, Al₂O₃, SiO₂, and insulating materials including Al₂O₃ and/or SiO₂; zinc oxide, titanium oxide, and semiconductor materials including zinc oxide and/or titanium oxide; and organic materials such as polyimide. In particular, materials showing a reversible oxidation-reduction reaction are preferable.

For example, fine particles of conductive or semiconductive metal oxides, such as antimony-tin oxide and nickel oxide, can be fixed on the counter electrode with a binder of acrylic type, alkyd type, isocyanate type, urethane type, epoxy type, phenol type, or the like.

The protective layer can be formed by vacuum vapor deposition method, sputtering method, ion plating method, or the like method. In the case where the protective layer material is coatable, the following methods can also be employed: spin coating method, casting method, micro gravure coating method, gravure coating method, bar coating method, roll coating method, wire bar coating method, dip coating method, slit coating method, capillary coating method, spray coating method, nozzle coating method, and various printing methods, such as gravure printing method, screen printing method, flexo printing method, offset printing method, reverse printing method, and inkjet printing method.

### Through Hole

It is preferable that the counter electrode and the display electrode are electrically connected to the multiple sub pixels through the through hole. The though hole can be formed by the following non-limiting methods.

(a) Forming a convex-shaped structural body, such as micro pillar, before forming the flattening layer, and removing the convex-shaped structural body after forming the flattening layer.
(b) Photolithography using a photosensitive resin.
(c) Directly irradiating the display electrode with radiation to form fine holes. In particular, laser processing methods using pulse laser or the like are preferable, because laser strength and wavelength are easily controllable, and a proper processing procedure is selectable depending on the type of the material to which holes are to be formed.

A material for filling the through hole is not limited to any particular material so long as it has conductivity. Materials forming the counter electrode and the display electrode and forming methods thereof can be used. Depending on the depth of the through hole, such materials and methods can also be used in combination. For example, by dropping a metal nano-ink, such as silver nano-metal ink, into the through hole by an inkjet method after forming the through hole, and then forming electrode layers, such as a counter electrode and a display electrode, electrical connection between the sub pixels and the electrode layers can be advantageously improved.

### Flattening Layer

It is preferable to provide a flattening layer for flattening irregularities of the drive circuit composing sub pixels. Specific examples of materials for use in the flattening layer include, but are not limited to, epoxy resin, phenol resin, urethane resin, polyimide resin, acrylic resin, and polyamide-imide resin. These resin materials are preferable for their ease in forming the flattening layer.

The flattening layer can be formed by spin coating method, casting method, micro gravure coating method, gravure coating method, bar coating method, roll coating method, wire bar coating method, dip coating method, slit coating method, capillary coating method, spray coating method, nozzle coating method, and various printing methods, such as gravure printing method, screen printing method, flexo printing method, offset printing method, reverse printing method, and inkjet printing method.

The flattening layer can be formed of either a transparent material or an opaque material. In particular, the flattening layer formed of a white material is advantageous because of combining the white reflective layer.

It is preferable that the flattening layer and/or the protective layer are/is formed between the second electrode and the white reflective layer.

### White Reflective Layer

The white reflective layer is for enhancing the reflectance of white color in the case where the electrochromic display element is used as a reflective display device. The white reflective layer is inserted between the second electrode formed of the transparent conductive film and the reflective layer.

The white reflective layer can be formed by applying a resin in which white pigment particles are dispersed. Specific examples of the white pigment material include, but are not limited to, titanium oxide, aluminum oxide, zinc oxide, silica, cesium oxide, yttrium oxide, and zirconium oxide. Specific examples of the resin in which white pigment particles are dispersed include, but are not limited to, polymeric resin materials such as epoxy resin, phenol resin, urethane resin, polyimide resin, acrylic resin, and polyamide-imide resin. In addition, white resists available from Goo Chemical Co., Ltd., Tamura Corporation, Taiyo Ink Mfg. Co., Ltd., or the like, can be used for the white reflective layer. It is easy to form through holes thereto by conventional lithography and etching.

The white reflective layer can be formed by spin coating method, casting method, micro gravure coating method, gravure coating method, bar coating method, roll coating method, wire bar coating method, dip coating method, slit coating method, capillary coating method, spray coating method, nozzle coating method, and various printing methods, such as gravure printing method, screen printing method, flexo printing method, offset printing method, reverse printing method, and inkjet printing method.

### Porous Insulating Layer

The porous insulating layer electrically insulates the display electrodes (the first or second electrode and the pixel electrode) from the counter electrode (the first or second electrode). The porous insulating layer is not limited to any particular material so long as it is porous. Porous organic, inorganic, or organic-inorganic composite material having high insulation property, durability, and film-formation property are preferable used.

A porous film for use in the porous insulating layer can be formed by the following methods: sintering method in that polymer fine particles or inorganic particles are partially fused with each other via a binder to form pores between the particles; extraction method in that solvent-soluble organic or inorganic substances and solvent-insoluble binders are formed into a layered structure, and the organic or inorganic substances are dissolved with a solvent to form pores; foaming method in that a high-molecular-weight polymer or the like is foamed by means of heating or degassing; phase inversion method in that a mixture of polymers is subjected to phase separation by handling a good solvent and a poor solvent; and radiation irradiation method in that pores are formed by means of radiation.

Specific examples of the porous insulating layer include, but are not limited to, a resin-mixed particle film composed of fine metal oxide particles (e.g., SiO₂ particles, Al₂O₃ particles) and a resin binder, a porous organic film (e.g., polyurethane resin, polyethylene resin), and an inorganic insulating material film formed on a porous film.

The metal oxide particles contained in the porous insulating layer preferably have a particle diameter in the range of 5 to 300 nm. The porous insulating layer preferably has porosity for exhibiting electrolyte permeability. For enhancing the porosity (i.e., void ratio), the metal oxide particles preferably have a larger particle diameter. On the other hand, in view of conductivity of the first or second electrode (display electrode and pixel electrode) formed of the transparent conductive film which is formed on the insulating layer, the metal oxide particles preferably have a smaller particle diameter to make the insulating layer flat. Compared to spherical metal oxide particles, needle-like, rosary-like, and chain-like metal oxide particles provide a higher porosity, which is advantageous in terms of electrolyte permeability. The insulating layer advantageously achieves high porosity and flatness by use of a laminated or composite body of these metal oxide particles.

The insulating layer is preferably combined with an inorganic film. In this case, when the display electrode which is disposed between the first electrode closest to the first substrate (display substrate) and the second electrode (e.g., between the display electrode and the counter electrode) is formed by a sputtering method, damage to organic substances included in the underlying insulating and electrochromic layers can be reduced.

The inorganic film is preferably formed of a material containing ZnS. ZnS has such a feature that it can be formed into a film by a sputtering method at high speeds without damaging the electrochromic layer and the like layers. In addition, materials containing ZnS as a major component, such as ZnS—SiO₂, ZnS—SiC, ZnS—Si, and ZnS—Ge, can also be used. The content ratio of ZnS in the material is preferably in the range of about 50% to 90% by mol for maintaining crystallinity of the insulating layer. In particular, ZnS—SiO₂(8/2), ZnS—SiO₂(7/3), ZnS, and ZnS—ZnO—In₂O₃—Ga₂O₃(60/23/10/7) are preferable.

By use of such materials, the insulating layer provides excellent insulating effect even when being thin. At the same time, deterioration in film strength or layer separation, which may be caused in a multilayer structure, can be prevented.

### Electrochromic Layer

The electrochromic layer contains an electrochromic material. Specific examples of the electrochromic material include both an inorganic electrochromic compound and an organic electrochromic compound. Specific examples of the electrochromic material further include a conductive polymer which shows electrochromism. Specific examples of the inorganic electrochromic compound include, but are not limited to, tungsten oxide, molybdenum oxide, iridium oxide, and titanium oxide. Specific examples of the organic electrochromic compound include, but are not limited to, viologen, rare-earth phthalocyanine, and styryl. Specific examples of the conductive polymer include, but are not limited to, polypyrrole, polythiophene, polyaniline, and derivatives thereof

In particular, the electrochromic layer preferably has such a configuration that conductive or semiconductive particles are bearing an organic electrochromic compound.

More specifically, the electrochromic layer is preferably composed of an electrode, the surface of which is sintered with fine particles having a particle diameter in the range of about 5 to 50 nm, to the surfaces of which an organic electrochromic compound having a polar group (e.g., phosphonate group, carboxyl group, silanol group) is adsorbed. With such a configuration, electrons are effectively injected into the organic electrochromic compound owing to the large surface effect of the fine particles. An electrochromic display element with such a configuration is capable of responding more rapidly compared to a conventional one. In addition, by use of the fine particles, the electrochromic layer can be formed into a transparent display layer, thereby providing high color development density of the electrochromic dye. It is possible that multiple types of organic electrochromic compounds are borne by the conductive or semiconductive particles.

Specific examples of polymer-based and dye-based electrochromic compounds include, but are not limited to, low-molecular-weight organic electrochromic compounds of azobenzene type, anthraquinone type, diarylethene type, dihydroprene type, dipyridine type, styryl type, styrylspiropyran type, spirooxazine type, spirothiopyran type, thioindigo type, tetrathiafulvalene type, terephthalic acid type, triphenylmethane type, triphenylamine type, naphthopyran type, viologen type, pyrazoline type, phenazine type, phenylenediamine type, phenoxazine type, phenothiazine type, phthalocyanine type, fluoran type, fulgide type, benzopyran type, and metallocene type; and conductive polymer compounds such as polyaniline and polythiophene.

In particular, viologen compounds and dipyridine compounds are preferable. These compounds are low in color development-discharge voltage and provide excellent color values even when used for an electrochromic display device having multiple display electrodes. Specific examples of viologen compounds are described in JP-3955641-B and JP-2007-171781-A, the disclosure of each of which is incorporated herein by reference. Specific examples of dipyridine compounds are described in JP-2007-171781-A and JP-2008-116718-A, the disclosure of each of which is incorporated herein by reference.

More preferably, dipyridine compounds represented by the following formula (1) are preferable. These compounds are low in color development-discharge voltage and provide excellent color values by reduction potential even when used for an electrochromic display device having multiple display electrodes.

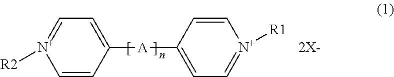

wherein each of R1 and R2 independently represents an alkyl group having 1 to 8 carbon atoms or an aryl group, each of which may have a substituent, with at least one of R1 and R2 has a substituent selected from COOH, PO(OH)₂, and Si(OCₖH₂ₖ₊₁)₃; X represents a monovalent anion; n represents an integer of 0, 1, or 2; k represents an integer of 0, 1, or 2; and A represents an alkylene group having 1 to 20 carbon atoms, an arylene group, or a divalent heterocyclic group which may have a substituent.

Specific examples of metal-complex-based and metal-oxide-based electrochromic compounds include, but are not limited to, inorganic electrochromic compounds such as titanium oxide, vanadium oxide, tungsten oxide, indium oxide, iridium oxide, nickel oxide, and Prussian Blue.

The conductive or semiconductive particles are not limited to any particular material, but are preferably formed of a metal oxide. Specifically, metal oxides composed primarily of the following compounds are preferable: titanium oxide, zinc oxide, tin oxide, zirconium oxide, cerium oxide, yttrium oxide, boron oxide, magnesium oxide, strontium titanate, potassium titanate, barium titanate, calcium titanate, calcium oxide, ferrite, hafnium oxide, tungsten oxide, iron oxide, copper oxide, nickel oxide, cobalt oxide, barium oxide, strontium oxide, vanadium oxide, aluminosilicate, and calcium phosphate. Each of these metal oxides can be used either alone or in combination with the others. In view of electric property, such as electric conductivity, and physical property, such as optical property, multi-color display providing high response speed in color development-discharge can be achieved by using one member selected from titanium oxide, zinc oxide, tin oxide, zirconium oxide, iron oxide, magnesium oxide, indium oxide, and tungsten oxide, or a mixture thereof. In particular, multi-color display providing much higher response speed in color development-discharge can be achieved by using titanium oxide.

The conductive or semiconductive particles are not limited in shape. Preferably, the conductive or semiconductive particles have a shape which has a large surface area per unit volume (hereinafter “specific surface area”) for effectively bearing the electrochromic compound. For example, in the case where the particles are composed of aggregate of nano particles, the particles can effectively bear the electrochromic compound owing to their large specific surface area, providing multi-color display with an excellent display contrast ratio between color development and discharge.

Preferably, the electrochromic layer is composed of a porous electrode formed of a porous transparent conductive film having ion-permeable through holes and electrochromic molecules modifying a surface of the porous electrode.

### Electrolyte

The electrolyte is composed of an electrolyte substance and a solvent dissolving the electrolyte substance. The counter electrode, display electrode, electrochromic layer, etc., are impregnated with the electrolyte after the formation processes thereof. Alternatively, it is possible to first distribute the electrolyte substance in the display electrode, electrochromic layer, insulating layer, etc., in the process of forming these layers, and then impregnating the layers with the solvent at the time the display substrate and the counter substrate are stuck together. In the latter method, the layers will be impregnated at a higher speed owing to the osmotic pressure of the electrolyte.

Specific examples of the electrolyte substance include, but are not limited to, inorganic ion salts such as alkali metal salts and alkali-earth metal salts, quaternary ammonium salts, and supporting salts of acids and bases. More specifically, LiClO₄, LiBF₄, LiAsF₆, LiPF₆, LiCF₃SO₃, LiCF₃COO, KCl, NaClO₃, NaCl, NaBF₄, NaSCN, KBF₄, Mg(ClO₄)₂, Mg(BF₄)₂, and the like can be used. In addition, ionic liquids can also be used. All ionic liquids having been generally researched or reported can be used. In particular, an organic ionic liquid generally has a molecular structure which shows liquidity in a wide temperature range including room temperature. Such a molecular structure is formed by combining a cationic component and an anionic component. Specific examples of the cationic component include, but are not limited to, aromatic salts such as imidazole derivatives (e.g., N,N-dimethylimidazole salt, N,N-methylethylimidazole salt, N,N-methylpropylimidazole salt) and pyridinium derivatives (e.g., N,N-dimethylpyridinium salt, N,N-methylpropylpyridinium salt), and aliphatic quaternary ammonium salts such as tetraalkylammonium salts (e.g., trimethylpropylammonium salt, trimethylhexylammonium salt, triethylhexylammonium salt). In view of stability in the atmosphere, the anionic component is preferably selected from fluorine-containing compounds such as BF₄, CF₃SO₃⁻, PF₄, and (CF₃SO₂)₂N⁻. Ionic liquids prepared by a combination of these cationic and anionic components are preferable.

Specific examples of the solvent include, but are not limited to, propylene carbonate, acetonitrile, γ-butyrolactone, ethylene carbonate, sulfolane, dioxolan, tetrahydrofuran, 2-methyltetrahydrofuran, dimethylsulfoxide, 1,2-dimethoxyethane, 1,2-ethoxymethoxyethane, polyethylene glycol, alcohols, and mixed solvents thereof.

The electrolyte needs not necessarily be a low-viscosity liquid and may be in the form of gel, cross-linked polymer, liquid crystal dispersion, or the like. Preferably, the electrolyte is in the form of gel or solid, for improving element strength and reliability and preventing color development diffusion. In terms of fixation, it is preferable that the electrolyte substance and the solvent are retained in a polymer resin. In this case, high ion conductivity and solid strength are provided. In addition, it is preferable that the polymer resin is a photo-curable resin. In this case, an element can be produced at a lower temperature within a shorter time period, compared to a case in which a thin film is formed by thermal polymerization or solvent evaporation.

### First Substrate

The first substrate can be formed of any organic or inorganic material which is transparent.

Specific examples of such materials include, but are not limited to, resin materials (e.g., epoxy resin, phenol resin, urethane resin, polyimide resin, acrylic resin, polyamide-imide resin), metal oxides (e.g., aluminum oxide, silicon oxide, titanium oxide, zinc oxide), and composite materials thereof. The first substrate can be formed by the above-described various printing methods, such as spin coating method, and various vacuum film formation methods, such as vacuum vapor deposition method, chemical vapor-phase growth method, and sputtering method.

The first substrate can also be formed of a plastic substrate or a glass substrate. By laminating a plastic substrate on the first substrate impregnated with the electrolyte, a protective layer can be easily formed.

For improving water vapor barrier property, gas barrier property, and visibility, a transparent insulating layer and/or an antireflection layer can be formed on the front and/or back surface of the first substrate.

A method of producing the electrochromic display device according to an embodiment of the present invention is described in detail below.

In accordance with some embodiments of the present invention, a method of producing an electrochromic display device includes: 1) forming a flattening layer on a drive substrate, and forming a through hole; 2) forming a reflective layer serving as a mirror electrode on the flattening layer; 3) forming a white reflective layer on the reflective layer, forming a flattening film on the white reflective layer, and forming a through hole; 4) forming a pair of a second electrode, formed of a transparent film, and an optional electrochromic layer adjacent to the second electrode on the flattening film; 5) optionally forming a pair of a pixel electrode and an electrochromic layer adjacent to the pixel electrode between the second electrode and a first electrode, formed of a transparent film, via a porous insulating layer, and forming a through hole; 6) forming the first electrode on the pair of the second or pixel electrode and the electrochromic layer adjacent thereto via a porous insulating layer, or on a pair of a first substrate and an optional electrochromic layer adjacent to the first substrate; 7) dividing into pixels; and 8) sticking the drive substrate having the layers formed in the steps 1) to 6) thereon and the first substrate optionally having the layers formed in the step 6) thereon together while filling the layers disposed therebetween with an electrolyte.

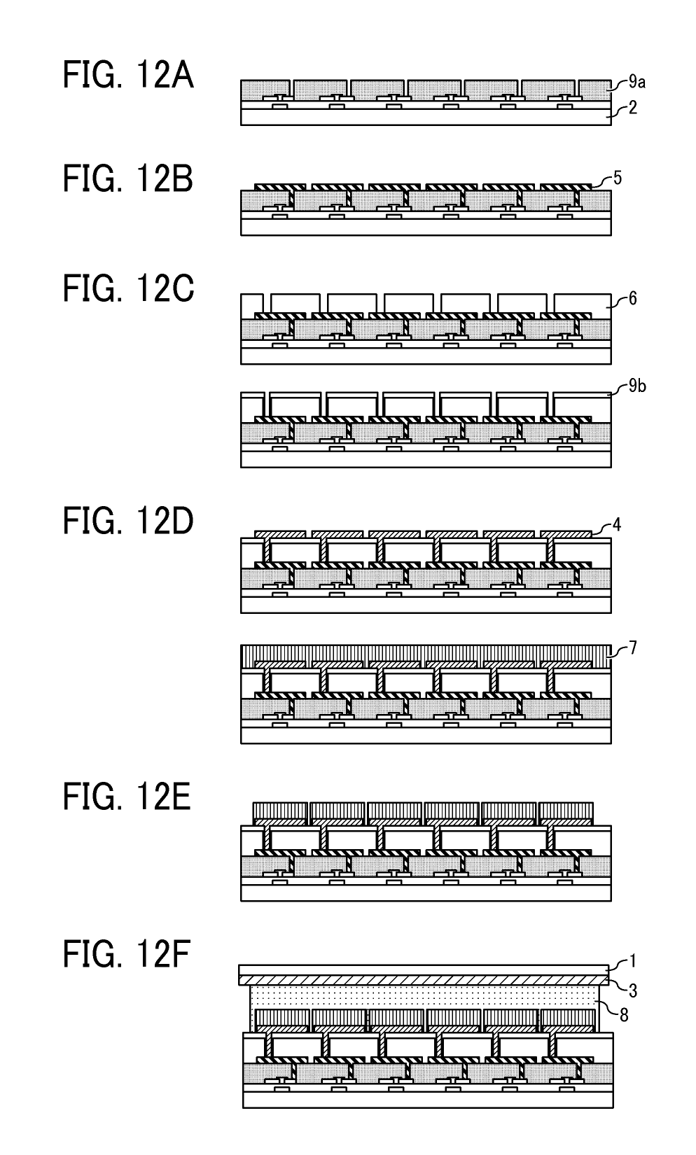

FIG. 10 is a flowchart showing a method of producing an electrochromic display device according to some embodiments of the present invention.

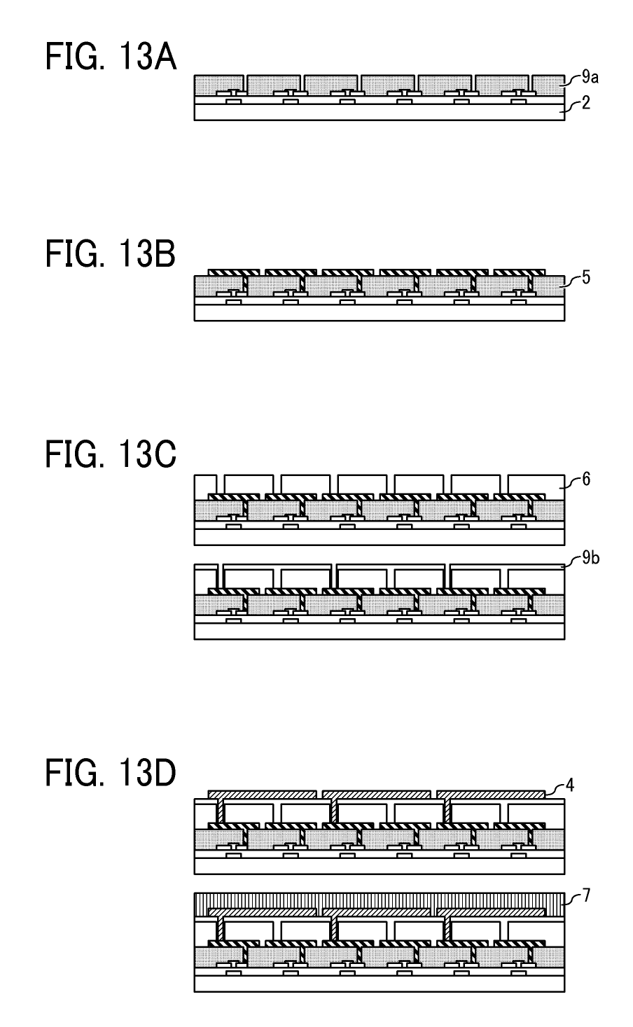

FIG. 11 is a flowchart showing a method of producing an electrochromic display device according to the eighth embodiment of the present invention. A method of producing the electrochromic display device is described in detail below with reference to FIGS. 10 and 11.

In accordance with the eighth embodiment of the present invention, the first electrode or the second electrode is composed of pixel electrodes arranged in a matrix, and each pair of the pixel electrode and the electrochromic layer adjacent to the pixel electrode is set apart.

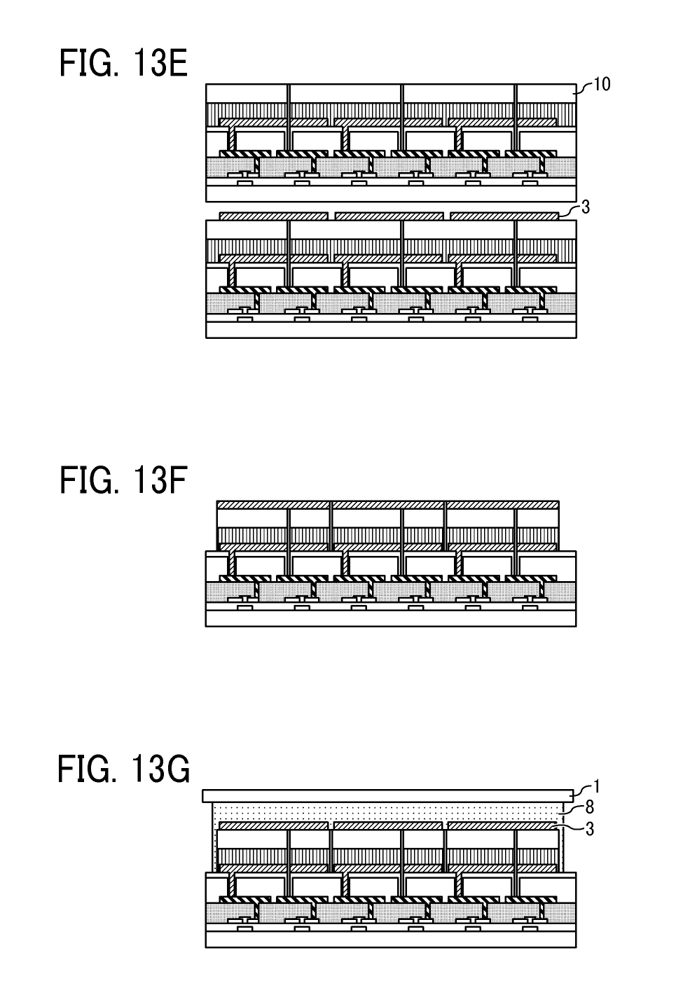

FIGS. 12A to 12F, 13A to 13G, and 14A to 14H are schematic views illustrating processes for producing electrochromic display devices according to the eighth embodiment of the present invention. These processes are broadly divided into the steps shown in the flow chart illustrated in FIG. 11.

The electrochromic device produced by the processes illustrated in FIGS. 12A to 12F has a layer structure similar to that illustrated in FIG. 2A (the flattening layer 9a is omitted in FIG. 2A). The first electrode is disposed in contact with a surface of the first substrate. The electrochromic device produced by the processes illustrated in FIGS. 13A to 13G has a layer structure similar to that illustrated in FIG. 3A. The first electrode is disposed not in contact with a surface of the first substrate but on the electrochromic layer adjacent to the second electrode via the insulating layer.

The electrochromic device produced by the processes illustrated in FIGS. 14A to 14H has a layer structure in that the first electrode is disposed in contact with a surface of the first substrate, the pair of the second electrode and the electrochromic layer adjacent to the second electrode is formed on the flattening layer, and one pair of an electrode formed of a transparent conductive film and an electrochromic layer adjacent to the electrode is disposed between the first electrode and the second electrode via an insulating layer.

A method of producing an electrochromic display device includes the following steps.

(S1) A step of forming a flattening layer on a drive substrate, and forming a through hole.
(S2) A step of forming a reflective layer (mirror electrode) on the flattening layer.
(S3) A step of forming a white reflective layer on the reflective layer (mirror electrode), forming a flattening film on the white reflective layer, and forming a through hole.
(S4) A step of forming a pair of a second electrode (pixel electrode) and an electrochromic layer adjacent to the pixel electrode on the flattening film.

A step of forming one or more pairs of a pixel electrode formed of a transparent conductive film and an electrochromic layer adjacent to the pixel electrode between the first electrode and the second electrode may be introduced, if necessary. (This step is required in the processes illustrated in FIGS. 14A to 14H, but is not required in the processes illustrated in FIGS. 12A to 12F and 13A to 13G.)

The following steps (S4′) and (S4-2) may be introduced, if necessary.

(S4′) A step of forming an insulating layer on the pair of the second electrode (pixel electrode) and the electrochromic layer adjacent to the pixel electrode, and forming a through hole.
(S4-2) A step of forming a pair of a pixel electrode (transparent electrode film) and an electrochromic layer adjacent to the pixel electrode on the insulating layer.

A step of forming a first electrode (transparent conductive film) may be introduced, if necessary. (This step is required in the processes illustrated in FIGS. 13A to 13G, but is not required in the processes illustrated in FIGS. 12A to 12F and 14A to 14H.)

The following step (S4″) may be introduced, if necessary.

(S4″) A step of forming an insulating layer, a through hole, and a first electrode (transparent conductive film), on the pair of the second or pixel electrode and the electrochromic layer adjacent thereto.

The series of the steps (S1) to (S4), (S1) to (S4-2), or (S1) to (S4″) is followed by the following steps.

(S5) A step of dividing into pixels.
(S6) A step of sticking the drive substrate having the above-formed layers thereon and the first substrate optionally having the first electrode thereon together while filling the layers disposed therebetween with an electrolyte.

These steps are described in detail below.

In FIGS. 12A to 12F, an electrochromic display device is produced by the following steps.

(S1) A step of forming a flattening layer on a drive substrate, and forming first through holes (reaching all sub pixels) on the flattening layer.
(S2) A step of forming reflective layers (mirror electrodes).
(S3) A step of forming a white reflective layer, a step of forming second through holes (reaching all the mirror electrodes) on the white reflective layer, a step of forming a flattening film, and a step of forming third though holes (reaching all the mirror electrodes) smaller than the second through holes.
(S4) A step of forming second electrodes (pixel electrodes; display electrodes), and a step of forming an electrochromic layer.
(S5) A step of dividing into pixels.
(S6) A step of sticking the drive substrate having the above-formed layers thereon and a first substrate having a first electrode thereon while filling the layers disposed therebetween with an electrolyte.

In FIGS. 13A to 13G, an electrochromic display device is produced by the following steps.

(S1) A step of forming a flattening layer on a drive substrate, and forming first through holes (reaching all sub pixels) on the flattening layer.
(S2) A step of forming reflective layers (mirror electrodes).
(S3) A step of forming a white reflective layer, a step of forming second through holes on the white reflective layer, a step of forming a flattening film, and a step of forming third though holes (reaching first mirror electrodes) smaller than the second through holes.
(S4) A step of forming second electrodes (pixel electrodes; display electrodes), and a step of forming an electrochromic layer.
(S4″) A step of forming a porous insulating layer, a step of forming fourth though holes (reaching second mirror electrodes), smaller than the second through holes, penetrating the porous insulating layer, the electrochromic layer, the flattening film, and the white reflective layer, and a step of forming first electrodes (counter electrodes).
(S5) A step of dividing into pixels.
(S6) A step of sticking the drive substrate having the above-formed layers thereon and a first substrate while filling the layers disposed therebetween with an electrolyte.

In FIGS. 14A to 14H, an electrochromic display device is produced by the following steps.

(S1) A step of forming a flattening layer on a drive substrate, and forming first through holes (reaching all sub pixels) on the flattening layer.
(S2) A step of forming reflective layers (mirror electrodes).
(S3) A step of forming a white reflective layer, a step of forming second through holes (reaching all the mirror electrodes) on the white reflective layer, a step of forming a flattening film, and a step of forming third though holes (reaching first mirror electrodes) smaller than the second through holes.
(S4-1) A step of forming second electrodes (pixel electrodes; display electrodes), and a step of forming a first electrochromic layer.
(S4′) A step of forming a porous insulating layer, and a step of forming fourth though holes (reaching second mirror electrodes), smaller than the second through holes, penetrating the porous insulating layer, the first electrochromic layer, the flattening film, and the white reflective layer.
(S4-2) A step of forming pixel electrodes (display electrodes), and a step of forming a second electrochromic layer.
(S5) A step of dividing into pixels.
(S6) A step of sticking the drive substrate having the above-formed layers thereon and a first substrate while filling the layers disposed therebetween with an electrolyte.

The electrochromic display device illustrated in FIG. 8 is produced by the following steps.

(S1) A step of forming a flattening layer on a drive substrate, and first through holes (reaching all sub pixels) on the flattening layer.
(S2) A step of forming reflective layers (mirror electrodes).
(S3) A step of forming a white reflective layer, a step of forming second through holes (reaching all the mirror electrodes) on the white reflective layer, a step of forming a flattening film, and a step of forming a third though hole (reaching a first mirror electrode) smaller than the second through holes.
(S4-1) A step of forming pixel electrodes I (second electrodes; display electrodes I), and a step of forming a first electrochromic layer.
(S4′) A step of forming a porous insulating layer, and a step of forming a fourth though hole (reaching a second mirror electrode), smaller than the second through holes, penetrating the porous insulating layer, the first electrochromic layer, the flattening film, and the white reflective layer.
(S4-2) A step of forming pixel electrodes II (display electrodes II), and a step of forming a second electrochromic layer.
(S4′) A step of forming a porous insulating layer, and a step of forming a fifth though hole (reaching a third mirror electrode) smaller than the second through holes.
(S4-3) A step of forming pixel electrodes III (display electrodes III), and a step of forming a third electrochromic layer.
(S4′) A step of forming a porous insulating layer, and a step of forming a sixth though hole (reaching a fourth mirror electrode) smaller than the second through holes, and a step of forming a first electrode.
(S5) A step of dividing into pixels.
(S6) A step of sticking the drive substrate having the above-formed layers thereon and a protective film as a substitute for a first substrate while filling the layers disposed therebetween with an electrolyte.

Each of the above-described steps is described in detail below.

### (S1) Step of Forming Flattening Layer and Through Hole

First, a flattening layer is formed on a drive substrate. The flattening layer absorbs irregularities formed of drive circuits that are forming sub pixels, to make it possible to obtain a flat reflective layer (mirror electrode). The purpose of forming through holes on the flattening layer is to electrically connect the sub pixel to the reflective layer (mirror electrode). The flattening layer and through hole can be easily formed by known technologies. One example of known technologies includes photolithographic patterning using a resin material (e.g., a photoreactive epoxy). Another example includes laser processing which can directly form through holes.

### (S2) Step of Forming Reflective Layer (Mirror Electrode)

A reflective layer (mirror electrode) composed of a conductive metal having a high reflectance is formed on the flattening layer. The reflective layer can be formed by vacuum vapor deposition method, sputtering method, ion plating method, or the like method. In particular, an APC film formed in vacuum by sputtering method is preferred because of having improved environmental resistance and heat resistance while maintaining high reflectance and conductivity.

Because the reflective layer (mirror electrode) is connected to the sub pixel over the physical steps of the through holes, methods combining vacuum film formation and various printing methods are advantageous for forming the reflective layer (mirror electrode). When the through holes have a taper angle, the physical steps are deescalated, thereby securing reliability in the electric connection.

### (S3) Step of Forming White Reflective Layer, Flattening Film, and Through Hole

After a white reflective layer is formed on the reflective layer (mirror electrode) and a flattening film is formed on the white reflective layer, through holes connecting the flattening film to the reflective layer (mirror electrode) are formed.

### (S4) Step of Forming Pixel Electrode and Electrochromic Layer

A pixel electrode (e.g., the second electrode) and an electrochromic layer adjacent to the pixel electrode are formed.

In FIGS. 12A to 12F, pixel electrodes (e.g., the second electrodes) are formed first, and an electrochromic layer is formed thereafter. Alternatively, an electrochromic layer may be formed first, and pixel electrodes (e.g., the second electrodes) may be formed thereafter. Methods of forming the pixel electrode serving as a display electrode and the electrochromic layer are described in the detailed descriptions for Display Electrode and Electrochromic Layer.

Because the pixel electrode (e.g., the second electrode) and the electrochromic layer do not need patterning in this step, they can be formed by various vacuum film formation methods or printing methods.

As described above, one of the first and second electrodes is a display electrode and the other is a counter electrode. In FIGS. 12A to 12F, 13A to 13G, and 14A to 14H, the second electrode is a display electrode (pixel electrode) and the first electrode is a counter electrode.

According to the second embodiment, the step (S4) of forming pixel electrode and electrochromic layer is followed by the step (S5) of dividing pixels illustrated in FIG. 12E and the step (S6) of sticking substrates and filling with an electrolyte, as illustrated in FIG. 12F.

According to the fourth embodiment, the step (S4) is followed by a step of forming one or more pairs of a pixel electrode formed of a transparent conductive film and an electrochromic layer adjacent to the pixel electrode between the first electrode and the second electrode. In the processes illustrated in FIGS. 14A to 14H, the step (S4′) of forming an insulating layer on the pair of the pixel electrode (second electrode) and the electrochromic layer adjacent to the pixel electrode, and forming a through hole, and the step (S4-2) of forming a pair of a pixel electrode and an electrochromic layer adjacent to the pixel electrode on the insulating layer are introduced.

These steps involves a step of forming through holes to connect pixel electrodes to sub pixels, a step of forming an insulating layer, a step of forming smaller through holes, and a step of forming a pixel electrode and an electrochromic layer adjacent to the pixel electrode.

According to the fourth embodiment, the second step of forming through holes is conducted on sub pixels other than those having been exposed to the first step of forming through holes, as illustrated in FIG. 14F. The through holes are formed through the first electrochromic layer, the porous insulating layer, the pixel electrodes, and the flattening layer.

In a case where another electrochromic layer is further required, the number of sub pixels can be increased to provide the third pixel electrodes and the third electrochromic layer and to conduct the third step of forming through holes. In particular, by repeating the steps (S4′) and (S4-2), an electrochromic display device having a three-layer structure, as illustrated in FIG. 5, can be obtained.

Namely, such an electrochromic display device having multiple (two, in FIG. 5) pairs of an electrode formed of a transparent conductive film and an electrochromic layer adjacent to the electrode stacked between the first electrode and the second electrode via an insulating layer can be obtained.

The step (S4′) of forming an insulating layer on the pair of the pixel electrode (second electrode) and the electrochromic layer adjacent to the pixel electrode, and a through hole, is to electrically connect sub pixels with pixel electrodes to be formed, to form further electrochromic layer. In the step (S3), large through holes penetrating the white reflective layer and the flattening film reaching the reflective layer (mirror electrode) are formed in advance. An insulating layer is then formed, and through holes smaller than the large through holes are formed in the insulating layer. The smaller through holes electrically insulate the reflective layer (mirror electrode) from pixel electrodes and an adjacent electrochromic layer to be formed.

The through holes can be formed by known methods, as described above. One example of known methods includes laser processing which can directly form through holes.

In laser processing, an object is irradiated with laser so that the surface of the object is melted or vaporized and fine pores and grooves are formed thereon. Recently, pulse laser having an ultrashort pulse ranging from femtosecond to nanosecond and CW laser capable of continuous oscillating are known. Various kinds of oscillation wavelengths are known, ranging from infrared region to ultraviolet region. In this step, excimer laser and femtosecond titanium sapphire laser are useful in terms of processing. Excimer laser has an oscillation wavelength in ultraviolet region and a high oscillation output, and is useful in processing organic materials and metal oxide materials having an absorption in ultraviolet region. Femtosecond titanium sapphire laser is particularly useful because of having a high processing ability owing to its very short pulse width and high peak value, and being capable of beautifully processing with less thermal and chemical damage to the periphery of the laser-irradiated portion.

After the step (S4′) of forming an insulating layer on the pair of the pixel electrode (second electrode) and the electrochromic layer adjacent to the pixel electrode, and a through hole, the step (S4-2) of forming a pair of a pixel electrode (transparent electrode film) and an electrochromic layer adjacent to the pixel electrode on the insulating layer is introduced.

A step of forming a first electrode (transparent conductive film) may be introduced, if necessary.

A step of forming, on the pair of the second or pixel electrode and the electrochromic layer adjacent thereto, an insulating layer, a through hole, and a first electrode (transparent conductive film) may be introduced, if necessary.

The series of the steps (S1) to (S4), (S1) to (S4-2), or (S1) to S(4″) is followed by the following steps.

(S5) Step of Dividing into Pixels

The step of dividing into pixels is necessary for setting apart the display electrodes, electrochromic layers, and counter electrodes for each pixel. Laser processing is useful in this step. Laser processing is useful in terms of microfabrication that forms fine lines and dots by means of scanning an optical axis of laser or an object to be processed. In laser processing, it is possible to simultaneously process the display electrode, electrochromic layer, and counter electrode. Accordingly, the shapes of multiple display electrodes and counter electrodes are equalized and misalignment of the layers is suppressed in one pixel.

(S6) Step of Sticking Substrates and Filling with Electrolyte

In the step of sticking the drive substrate having the above-formed layers thereon and the first substrate optionally having an electrochromic layer thereon together while filling the layers disposed therebetween with an electrolyte, the materials and methods described in the detailed descriptions for Electrolyte or First Substrate can be used. The electrolyte suppresses bubbles generated in dividing pixels from being mixed in the multiple electrochromic layers or insulating layers.

A method of driving the electrochromic display device is described in detail below with reference to the electrochromic display device having four sub pixels and three electrochromic layers illustrated in FIG. 8.

The first sub pixel 14a is connected to the first electrode (counter electrode), and the second sub pixel 14b, third sub pixel 14c, and fourth sub pixel 14d are respectively connected to the pixel electrode I (second electrode) 11a, pixel electrode II (display electrode II) 11b, and pixel electrode III (display electrode III) 11C. Color-development and color-discharging driving of this electrochromic display device is conducted as follows.

### Color-Development and Color-Discharging Driving

By driving the driving circuits of sub pixels in such a manner that a potential difference is generated between the first electrode (counter electrode) and the pixel electrode I (second electrode, display electrode I), between the first electrode (counter electrode) and the pixel electrode II (display electrode II), or between the first electrode (counter electrode) and the pixel electrode III (display electrode III), the first electrochromic layer I, second electrochromic layer II, or third electrochromic layer III can independently develop or discharge color.

Accordingly, a method of driving the electrochromic display device can include a step of applying a voltage between a sub pixel composed of a driving circuit connected to the counter electrode composed of the first or second electrode via the reflective layer serving as the mirror electrode, and at least one of one or more sub pixels each composed of a driving circuit connected to a display electrode composed of the first, second, or pixel electrode via the reflective layer serving as the mirror electrode.

By driving the driving circuits of sub pixels in such a manner that the pixel electrode I (second electrode, display electrode I) and the pixel electrode II (display electrode II) have the same potential but a potential difference is generated between the first electrode (counter electrode), the first electrochromic layer I and second electrochromic layer II can simultaneously develop or discharge color.

By driving the driving circuits of sub pixels in such a manner that the pixel electrode I (second electrode, display electrode I), the pixel electrode II (display electrode II), and the pixel electrode III (display electrode III) have the same potential but a potential difference is generated between the first electrode (counter electrode), the first electrochromic layer I, second electrochromic layer II, and third electrochromic layer III can simultaneously develop or discharge color.

Although it seems that the first electrode (counter electrode) and each electrochromic layer are electrically connected in series, they are connected in parallel through the electrolyte in actual.

By driving the driving circuits of sub pixels in such a manner that a potential difference is generated between an arbitrary number of the pixel electrodes (display electrodes) and the first electrode (counter electrode), only a desired electrochromic layer can develop or discharge color. This indicates that even when one electrochromic layer reduces its color development density, the lack in color development density can be compensated by driving an arbitrary electrochromic layer to develop color, and the displayed image is corrected with less electric power consumption.

### EXAMPLES

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### Evaluation of Function of Reflective Layer

In the following Example 2 and Comparative Examples 2 and 3, electrochromic display elements are prepared, and the functions of their reflective layers are evaluated. Example 1 and Comparative Example 1 are test examples for evaluating the functions of the reflective layers.

### Example 1

On a glass substrate having a size of 40 mm×40 mm, a reflective layer composed of APC (an alloy of silver, palladium, and copper) having a film thickness of about 150 nm is formed by a sputtering method. Next, 1% by weight of an urethane paste (HW140SF available from DIC Corporation), serving as a binder polymer, is dissolved in 2,2,3,3-tetrafluoropropanol to prepare a solution. Further, 5% by weight of a titanium oxide particle (CR50 available from Ishihara Sangyo Kaisha, Ltd., having an average particle diameter of about 250 nm) is dispersed in the solution to prepare a paste. The paste is applied to the surface of the reflective layer by a spin coating method and subjected to an annealing treatment at 120° C. for 5 minutes. Thus, a white reflective layer having a thickness of about 700 nm is formed.

### Comparative Example 1

A white reflective layer is formed on a glass substrate in the same manner as Example 1 except that the APC reflective layer is not formed.

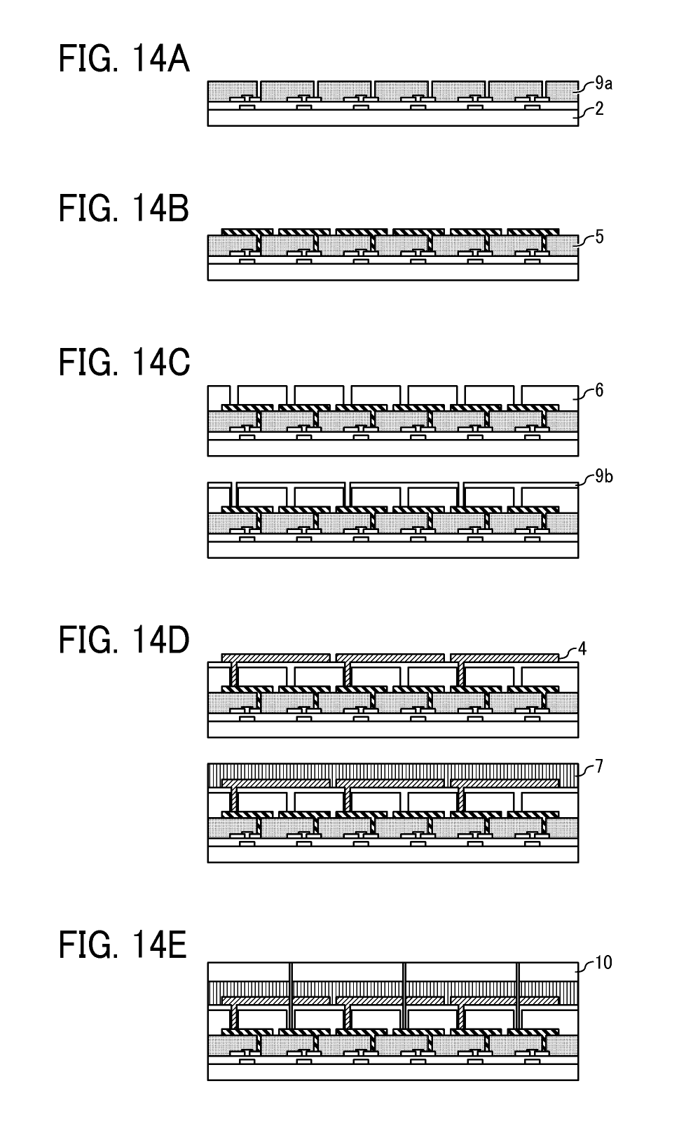

FIG. 15 shows reflectance spectra of the white reflective layers obtained in Example 1 and Comparative Example 1.

Reflectance spectrum is measured by emitting reference light to a sample at an incidence angle of 30° and measuring the reflected light at a measuring angle of 0° with reference to a standard white plate. FIG. 15 indicates that forward-scattered light is reflected by the reflective layer and re-scattered by the white reflective layer, and light is extracted out of the element.

### Example 2

An electrochromic display element illustrated in FIG. 2A according to the second embodiment is prepared as follows.

On a glass substrate (second substrate) having a size of 40 mm×40 mm, a reflective layer 5 composed of APC (an alloy of silver, palladium, and copper) having a film thickness of about 150 nm is formed by a sputtering method. Next, 1% by weight of an urethane paste (HW140SF available from DIC Corporation), serving as a binder polymer, is dissolved in 2,2,3,3-tetrafluoropropanol to prepare a solution. Further, 5% by weight of a titanium oxide particle (CR50 available from Ishihara Sangyo Kaisha, Ltd., having an average particle diameter of about 250 nm) is dispersed in the solution to prepare a paste. The paste is applied to the surface of the reflective layer by a spin coating method and subjected to an annealing treatment at 120° C. for 5 minutes. Thus, a white reflective layer 6 having a thickness of about 700 nm is formed.

A coating liquid prepared by adding an urethane resin, serving as a binder polymer, to an MEK dispersion paste of SiO₂ particles (MEK-ST available from Nissan Chemical Industries, Ltd., having an average particle diameter of about 10 nm) is applied to the white reflective layer by a spin coating method. The applied coating liquid is subjected to an annealing treatment at 120° C. for 5 minutes to form a SiO₂ particle layer having a thickness of about 500 nm. Thereafter, a ZnS—SiO₂(8/2) layer having a thickness of about 30 nm is formed thereon by a sputtering method. Thus, a bilayer flattening film 9b is formed. An ITO transparent conductive film (second electrode 4) having a film thickness of about 100 nm and a pattern having a size of 7 mm×30 mm is formed by a sputtering method. A titanium oxide nano particle dispersion liquid (SP210 available from Showa Titanium Co., Ltd.) is applied thereon by a spin coating method and subjected to an annealing treatment at 120° C. for 15 minutes. Thus, a titanium oxide particle film is formed.

Next, 1% by weight 2,2,3,3-tetrafluoropropanol solution of a viologen compound 4,4′-(1-phenyl-1H-pyrrole-2,5-diyl)bis(1-(4-(phosphonomethyl)benzyl)pyridinium)bromide that develops and discharges magenta color upon an oxidation-reduction reaction is applied thereon by a spin coating method. The applied coating liquid is subjected to an annealing treatment at 120° C. for 10 minutes, rinsed with 2,2,3,3-tetrafluoropropanol, and subjected to an annealing treatment again at 120° C. for 5 minutes. Thus, an electrochromic layer 7 composed of a titanium oxide porous electrode and an electrochromic compound is formed.

On another glass substrate (first substrate 1) having a size of 40 mm×40 mm, an ITO transparent conductive film (first electrode 3) having a film thickness of about 100 nm is formed by a sputtering method. An electrolyte 8 is prepared by dissolving an electrolyte substance tetrabutylammonium perchlorate in butylene carbonate to have a concentration of 0.1 M. After adding an UV-curable adhesive (PTC10 available from Jujo Chemical Co., Ltd.) in an amount of 30% by weight to the electrolyte, the electrolyte is dropped on the first substrate. The first substrate is superimposed on the above-prepared second substrate (glass substrate) and irradiated with ultraviolet ray. Thus, an electrochromic display element is prepared.

### Comparative Example 2

An electrochromic display element is prepared in the same manner as Example 2 except that the APC reflective layer is not formed. In other words, on the second substrate illustrated in FIG. 2A, the white reflective layer, flattening film, ITO transparent conductive film (second electrode), titanium oxide particle film, and electrochromic layer including an electrochromic compound are formed in this order. On the glass substrate (first substrate 1), the first electrode 3 is formed. The first substrate is superimposed on the second substrate in the same manner as Example 2 and irradiated with ultraviolet ray. Thus, an electrochromic display element is prepared.

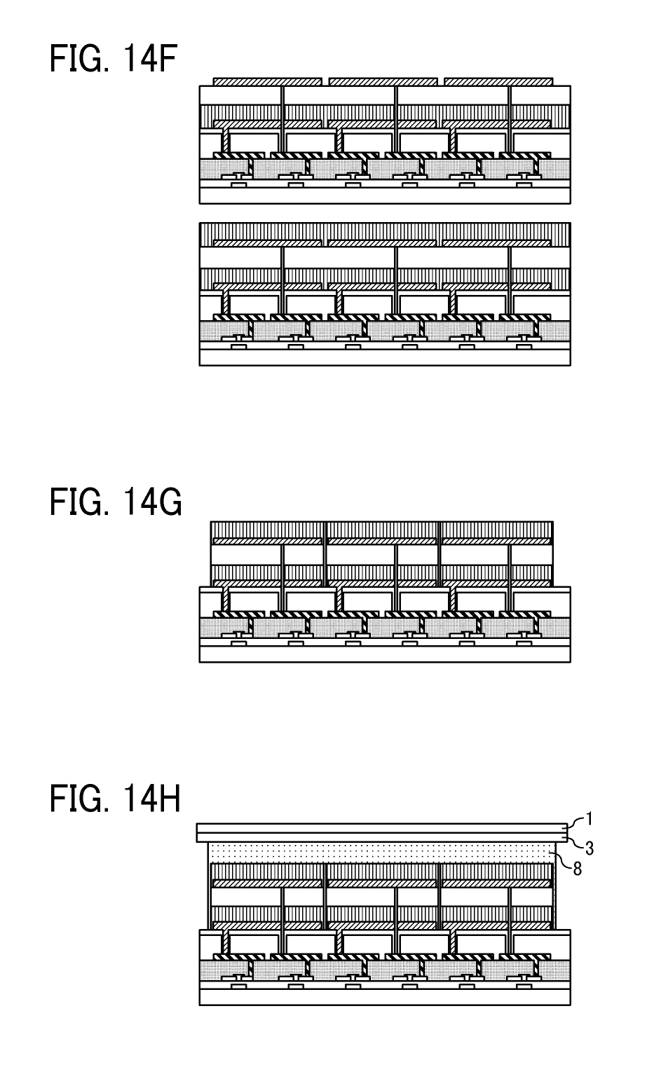

FIG. 16 shows reflectance spectra of the white reflective layers obtained in Example 2 and Comparative Example 2.

Reflectance spectrum is measured by emitting reference light to a sample at an incidence angle of 30° and measuring the reflected light at a measuring angle of 0° with reference to a standard white plate. FIG. 16 indicates that forward-scattered light is reflected by the reflective layer and re-scattered by the white reflective layer, and light is extracted out of the element. When the elements are driven by applying a voltage of −2.5 V (at color development) or +0.5 V (at color discharge) to the working electrode for 1 second, the responsiveness is in the same level in Example 2 and Comparative Example 2.

### Comparative Example 3

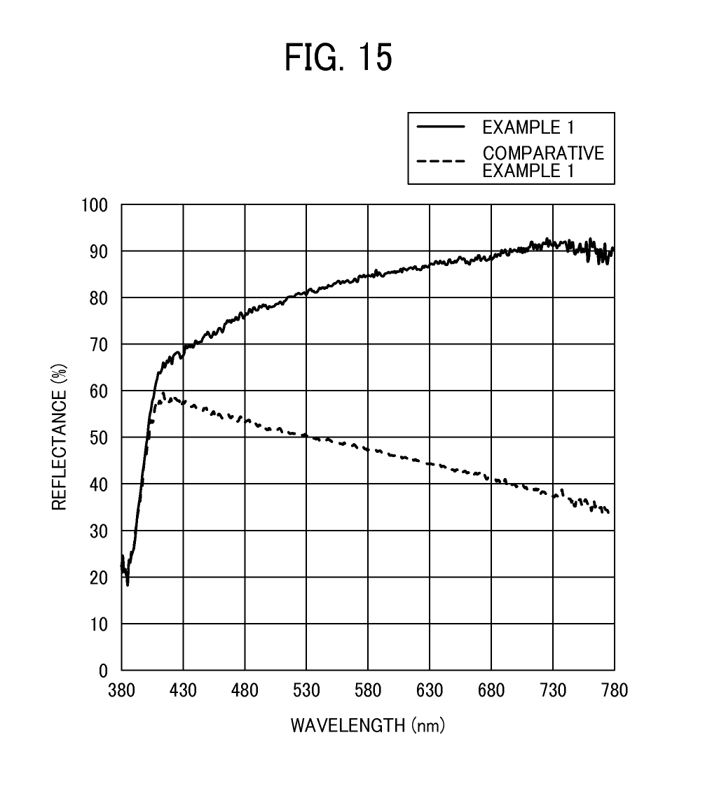

An electrochromic display element illustrated in FIG. 17 is prepared as follows.

On a glass substrate (first substrate 1) having a size of 40 mm×40 mm, an ITO transparent conductive film (first electrode 3) having a film thickness of about 100 nm is formed by a sputtering method. A titanium oxide nano particle dispersion liquid (SP210 available from Showa Titanium Co., Ltd.) is applied thereon by a spin coating method and subjected to an annealing treatment at 120° C. for 15 minutes. Thus, a titanium oxide particle film is formed.

Next, 1% by weight 2,2,3,3-tetrafluoropropanol solution of a viologen compound 4,4′-(1-phenyl-1H-pyrrole-2,5-diyl)bis(1-(4-(phosphonomethyl)benzyl)pyridinium)bromide that develops and discharges magenta color upon an oxidation-reduction reaction is applied thereon by a spin coating method. The applied coating liquid is subjected to an annealing treatment at 120° C. for 10 minutes, rinsed with 2,2,3,3-tetrafluoropropanol, and subjected to an annealing treatment again at 120° C. for 5 minutes. Thus, an electrochromic layer 7 composed of a titanium oxide porous electrode and an electrochromic compound is formed.

Next, 3% by weight of an urethane paste (HW140SF available from DIC Corporation), serving as a binder polymer, is dissolved in 2,2,3,3-tetrafluoropropanol to prepare a solution. Further, 15% by weight of a titanium oxide particle (CR50 available from Ishihara Sangyo Kaisha, Ltd., having an average particle diameter of about 250 nm) is dispersed in the solution to prepare a paste. The paste is applied to the surface of the electrochromic layer 7 by a spin coating method and subjected to an annealing treatment at 120° C. for 5 minutes. Thus, a white reflective layer 6 having a thickness of about 15 μm is formed.

On another glass substrate (second substrate 2a) having a size of 40 mm×40 mm, an ITO transparent conductive film (second electrode 4) having a film thickness of about 100 nm is formed by a sputtering method. An electrolyte 8 is prepared by dissolving an electrolyte substance tetrabutylammonium perchlorate in butylene carbonate to have a concentration of 0.1 M. After adding an UV-curable adhesive (PTC10 available from Jujo Chemical Co., Ltd.) in an amount of 30% by weight to the electrolyte, the electrolyte is dropped on the second substrate. The second substrate is superimposed on the above-prepared first substrate (glass substrate) and irradiated with ultraviolet ray. Thus, an electrochromic display element illustrated in FIG. 17 is prepared.

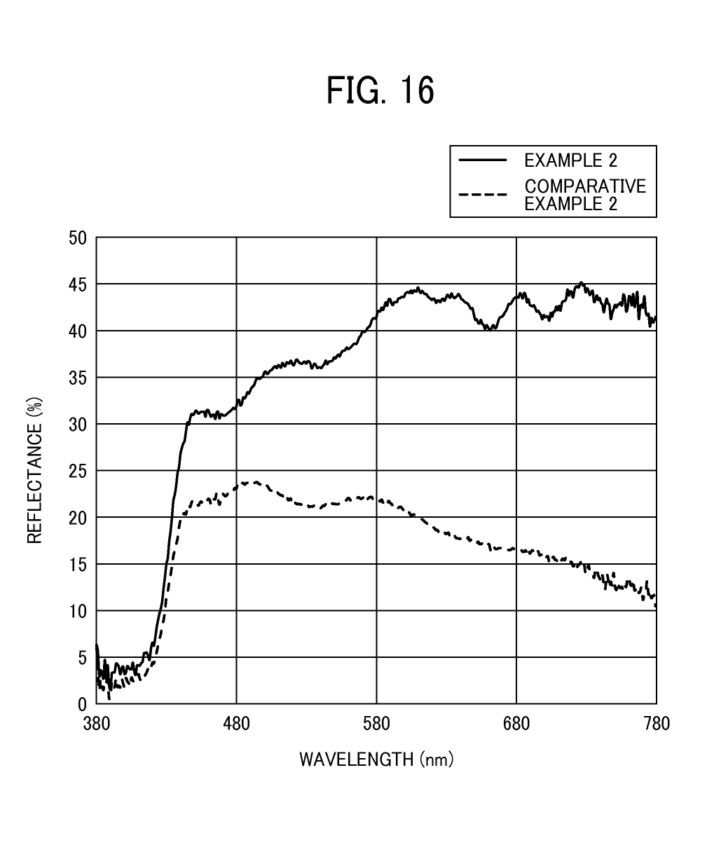

FIG. 18 shows reflectance response curves at 550 nm of the electrochromic display elements obtained in Example 2 and Comparative Example 3 upon application of rectangular voltage.

Reflectance spectrum is measured by emitting reference light to a sample at an incidence angle of 30° and measuring the reflected light at a measuring angle of 0° with reference to a standard white plate. The elements are driven by applying a voltage of −2.5 V (at color development) or +0.5 V (at color discharge) to the working electrode for 1 second. The reflectance response curves are standardized for the purposed of comparison. The graph shows that Example 2 has more excellent responsiveness compared to Comparative Example 3.

### Example 3

An electrochromic display element illustrated in FIG. 7 according to the eighth embodiment is prepared as follows.

On a glass substrate (second substrate) having a size of 40 mm×40 mm, a reflective layer 5 composed of a stacked film of APC (an alloy of silver, palladium, and copper) having a film thickness of about 100 nm and ITO (indium tin oxide) having a film thickness of about 10 nm, having a pattern, is formed by a sputtering method.

Next, a white reflective layer 6 is formed by a screen printing method using a white silicone resist ink (SWR-SA-901 available from Asahi Rubber Inc.). In this process, through holes having a size of about 50 μm×50 μm are formed by screen patterning, and a pattern having a size of 24 mm×24 mm is further formed.

On the white reflective layer 6, an ITO transparent conductive film (second electrode 4) having a film thickness of about 30 nm and a pattern having a size of 20 mm×20 mm is formed by a sputtering method.

A titanium oxide nano particle dispersion liquid (SP210 available from Showa Titanium Co., Ltd.) is applied thereon by a spin coating method and subjected to an annealing treatment at 120° C. for 5 minutes. Thus, a titanium oxide particle film is formed. Next, 1% by weight 2,2,3,3-tetrafluoropropanol solution of a viologen compound 4,4′-(1-phenyl-1H-pyrrole-2,5-diyl)bis(1-(4-(phosphonomethyl)benzyl)pyridinium)bromide that develops and discharges magenta color upon an oxidation-reduction reaction is applied thereon by a spin coating method. The applied coating liquid is subjected to an annealing treatment at 120° C. for 10 minutes, rinsed with 2,2,3,3-tetrafluoropropanol, and subjected to an annealing treatment again at 120° C. for 5 minutes. Thus, an electrochromic layer 7 composed of a titanium oxide porous electrode and an electrochromic compound is formed.

The resulting sample is subjected to a cutting processing by a laser processing equipment (HIPPO Prime 266-2 available from Spectra-Physics) with a power of 30 mW so that the electrochromic layer 7 and the second electrode 4 are cut into 6×6 matrix of pixels having a size of 3 mm×3 mm.

On another glass substrate (first substrate 1) having a size of 20 mm×40 mm, an ITO transparent conductive film (first electrode 3) having a film thickness of about 100 nm is formed by a sputtering method. An electrolyte 8 is prepared by dissolving an electrolyte substance tetrabutylammonium perchlorate in butylene carbonate to have a concentration of 0.1 M. After adding an UV-curable adhesive (PTC10 available from Jujo Chemical Co., Ltd.) in an amount of 30% by weight to the electrolyte, the electrolyte is dropped on the first substrate. The first substrate is superimposed on the above-prepared second substrate (glass substrate) and irradiated with ultraviolet ray. Thus, an electrochromic display element is prepared.

The contact resistance between the APC/ITO stacked film (reflective layer 5) and the ITO transparent conductive film (second electrode 4) is about 50Ω.

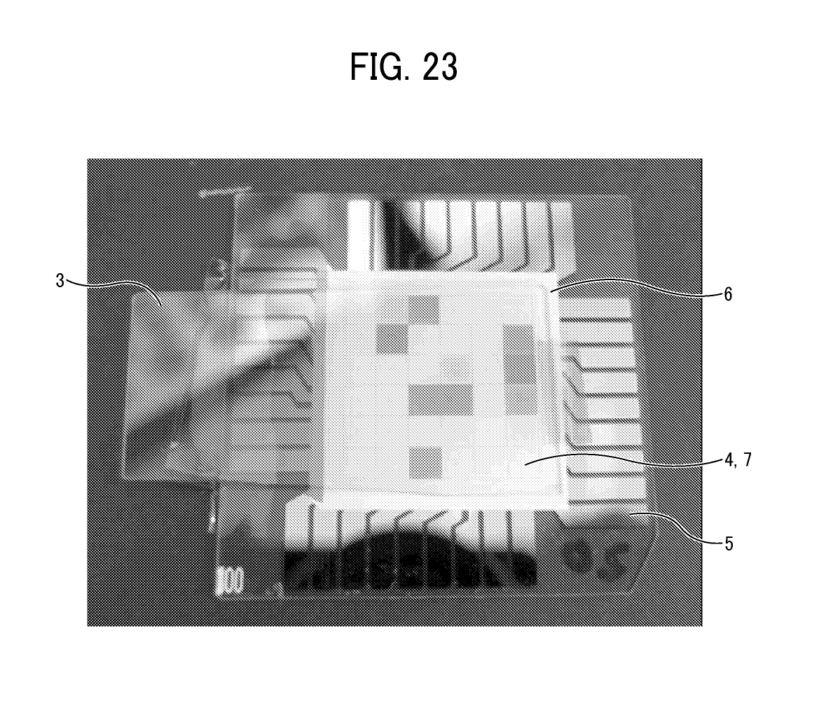

When a voltage of −2.5 V is applied to the working electrode (reflective layer 5), selected pixels develop color as shown in FIG. 23. When a voltage of +0.5 V is applied, the selected pixels discharge color.

### Example 4

Preparation of 3.5-inch Monolayer Panel The electrochromic display device in accordance with the third embodiment of the present invention, which includes a porous insulating layer between the first electrode and the second electrode, illustrated in FIG. 3C, is prepared according to the flowchart illustrated in FIG. 11.

A 3.5-inch low-temperature polysilicon TFT having a size of 240 pixels×320 pixels (QVGA: Quarter Video Graphics Array size) is prepared as the drive substrate 2. Each pixel has a size of 223.5 μm×223.5 μm. In Example 4, the electrochromic display device is prepared so that one pixel includes 4 pixels×4 pixels of the TFT. Accordingly, in the electrochromic display device of Example 4, one pixel has a size of 0.89 mm×0.89 mm. Among 16 pixels of the TFT in one pixel, 2 pixels are used as sub pixels.

### Step of Forming Reflective Layer (Mirror Electrode)

On the drive substrate, a flattening layer is formed. On the flattening layer, a reflective layer (mirror electrode) composed of a stacked film of a conductive metal (APC) having a high reflectance and a transparent conductive film (ITO) having a film thickness of about 110 nm is formed by a sputtering method, and a patterning in accordance with the pixel size is formed by photolithography.

### Step of Forming White Reflective Layer, Flattening Film, and Through Hole

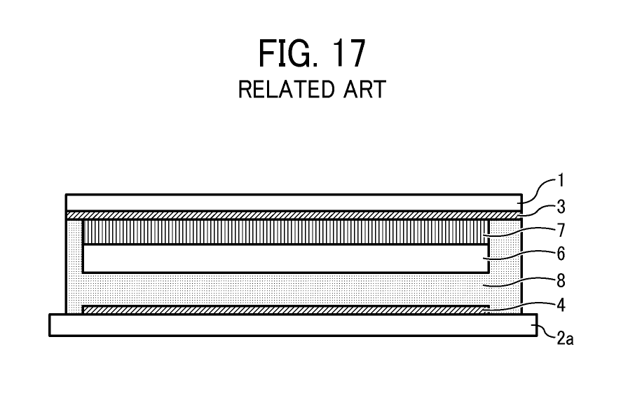

Next, a white reflective layer is formed by applying a white solder resist (PSR-550EXW (SW-399) available from Goo Chemical Co., Ltd.) to have a film thickness of about 6 μm by screen printing method. A first through hole 12a is then formed at the position illustrated in FIG. 19 by photolithography.

A coating liquid prepared by adding an urethane resin, serving as a binder polymer, to an MEK dispersion paste of SiO₂ particles (MEK-ST available from Nissan Chemical Industries, Ltd., having an average particle diameter of about 10 nm) is applied to the white reflective layer by a spin coating method. The applied coating liquid is subjected to an annealing treatment at 120° C. for 5 minutes to form a SiO₂ particle layer having a thickness of about 500 nm. Thereafter, a ZnS—SiO₂(8/2) layer having a thickness of about 30 nm is formed thereon by a sputtering method. Thus, a bilayer flattening film is formed.

After the flattening film is formed, through holes connecting the flattening film to the reflective layer (mirror electrode) are formed. Giving reference numbers to these through holes is omitted.

### Step of Forming Second Electrode (Counter Electrode)

Next, an ITO film having a film thickness of about 100 nm is formed all over the surface by a sputtering method, thereby forming a transparent counter electrode. The surface resistivity is about 90 n/square.

### Step of Forming Second Through Hole, Insulating Layer, and Third Through Hole Having Smaller Size

Next, a second through hole 12b having a size of 150 μm square is formed at the position illustrated in FIG. 19 by scanning the optical axis of a laser processing machine (Nd:YAG laser having a wavelength of 266 nm, a pulse width of 11 nanoseconds, and a strength of 12 mW). After several times of the scanning, the pixel electrode of TFT is exposed. The exposed area of the pixel electrode of TFT is about 120 μm square. Thus, a second through hole having a taper angle is formed.

A dispersion liquid of fine silica particles having an average primary particle diameter of 20 nm (including 13% by weight of solid contents of silica, 2% by weight of a polyvinyl alcohol resin (PVA 500), and 85% by weight of 2,2,3,3-tetrafluoropropanol) is applied by a spin coating method, and subjected to an annealing treatment for 10 minutes with a hot plate at 120° C. Thus, a porous insulating layer having a thickness of about 1 μm is formed. Further, a dispersion liquid of silica particles having an average particle diameter of 450 nm (including about 1% by weight of solid silica contents and 99% by weight of 2-propanol) is applied by a spin coating method.

Next, a third through hole 12c having a size of 80 nm square is formed at the position illustrated in FIG. 19 by scanning the optical axis of a laser processing machine (Nd:YAG laser having a wavelength of 266 nm, a pulse width of 11 nanoseconds, and a strength of 12 mW). After several times of the scanning, the pixel electrode of TFT is exposed. The exposed area of the pixel electrode of TFT is about 60 μm square. Thus, a third through hole having a taper angle is formed.

### Step of Forming First Electrode (Pixel Electrode; Display Electrode) and Electrochromic Layer

An ITO transparent conductive film having a film thickness of about 100 nm is formed all over the surface by a sputtering method. After emission of ultrasonic waves for 3 minutes in 2-propanol, the above-dispersed silica particles having a particle diameter of 450 nm are removed. Thus, a second electrode (pixel electrode; display electrode) having fine through holes is formed.

A titanium oxide fine particle dispersion liquid (SP210 available from Showa Titanium Co., Ltd.) is applied thereon by a spin coating method and subjected to an annealing treatment at 120° C. for 15 minutes. Thus, a titanium oxide particle film is formed. Further, 1% by weight 2,2,3,3-tetrafluoropropanol solution of an electrochromic compound that is a viologen derivative compound that develops magenta color is applied thereon by a spin coating method, and subjected to an annealing treatment at 120° C. for 10 minutes. Thus, an electrochromic layer composed of the titanium oxide particles and the electrochromic compound is formed.

Step of Dividing into Pixels

The optical axis of a laser processing machine (Nd:YAG laser having a wavelength of 266 nm, a pulse width of 11 nanoseconds, and a strength of 12 mW) is scanned along dotted lines shown in FIG. 19. After several times of the scanning, grooves having a width of about 50 μm are formed. It is confirmed by a white-color interference film thickness meter that the grooves are formed on the flattening layer with a certain amount of depth.

Step of Sticking Substrates and Filling with Electrolyte

An electrolyte substance tetrabutylammonium perchlorate is dissolved in butylene carbonate to have a concentration of 0.5 M. After adding an UV-curable adhesive (PTC10 available from Jujo Chemical Co., Ltd.) in an amount of 30% by weight thereto, the electrolyte is dropped on the drive substrate. The drive substrate is superimposed on the first substrate (glass substrate) and irradiated with ultraviolet ray. Thus, an electrochromic display device is prepared. The electrochromic display device has a white color reflectance of about 45%.

### Color Development Test

The above-prepared electrochromic display device is connected to a TFT driver equipped with FPGA and a personal computer, and subjected to a color development test.

The TFT is operated so that an 8.9-mm-square region develops color, by applying a voltage to the counter electrode corresponding to the region and the display electrode. It takes about 0.5 seconds to achieve magenta color development in that region. Further, the TFT is operated so that another 8.9-mm-square region which is partially overlapped with the above 8.9-mm-square region develops color. It takes about 0.5 seconds to achieve magenta color development in that region. In the overlapped region, deep magenta color development is achieved. After leaving the electrochromic display device for 20 minutes as it stands, display image stability is evaluated. Even after 60 minutes, the initial pattern remains, but color development density is attenuated to some degree.

Accordingly, an electrochromic display device for full-color display which prevents the occurrence of color blur between pixels is provided by using a single drive substrate. Display image retention performance is also excellent.

### Example 5

Preparation of 3.5-inch Multilayer Panel The electrochromic display device in accordance with the fourth embodiment of the present invention, which includes one or more pairs of an electrode formed of a transparent conductive film and an electrochromic layer adjacent to the pixel electrode, stacked between the first electrode and the second electrode via an insulating layer, is prepared according to the flowchart illustrated in FIG. 11.

A 3.5-inch low-temperature polysilicon TFT having QVGA size is prepared as the drive substrate 2 in the same manner as Example 1. In Example 5, the electrochromic display device is prepared so that one pixel includes 4 pixels×4 pixels of the TFT, either. Accordingly, in the electrochromic display device of Example 5, one pixel has a size of 0.89 mm×0.89 mm. Among 16 pixels of the TFT in one pixel, 3 pixels are used as sub pixels.

### Step of Forming Reflective Layer (Mirror Electrode)

On the drive substrate, a flattening layer is formed. On the flattening layer, a reflective layer (mirror electrode) composed of a stacked film of a conductive metal (APC) having a high reflectance and a transparent conductive film (ITO) having a film thickness of about 110 nm is formed by a sputtering method, and a patterning in accordance with the pixel size is formed by photolithography.

### Step of Forming White Reflective Layer, Flattening Film, and Through Hole

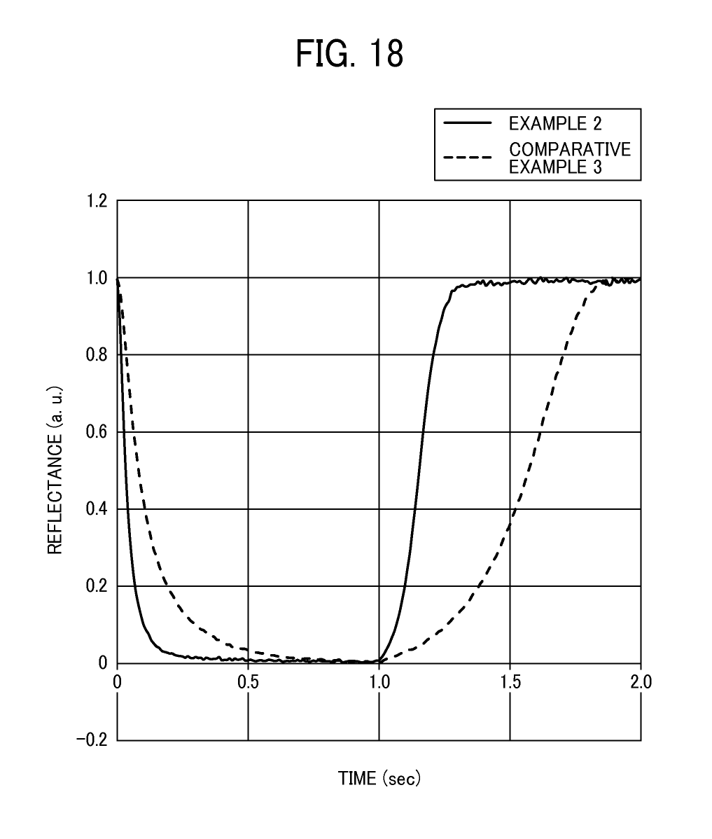

Next, a white reflective layer is formed by applying a white solder resist (PSR-550EXW (SW-399) available from Goo Chemical Co., Ltd.) to have a film thickness of about 6 μm by screen printing method. A first through hole 12a is then formed at the position illustrated in FIG. 20 by photolithography.

A coating liquid prepared by adding an urethane resin, serving as a binder polymer, to an MEK dispersion paste of SiO₂ particles (MEK-ST available from Nissan Chemical Industries, Ltd., having an average particle diameter of about 10 nm) is applied to the white reflective layer by a spin coating method. The applied coating liquid is subjected to an annealing treatment at 120° C. for 5 minutes to form a SiO₂ particle layer having a thickness of about 500 nm. Thereafter, a ZnS—SiO₂(8/2) layer having a thickness of about 30 nm is formed thereon by a sputtering method. Thus, a bilayer flattening film is formed.

After the flattening film is formed, through holes connecting the flattening film to the reflective layer (mirror electrode) are formed. Giving reference numbers to these through holes is omitted.

### Step of Forming Second Electrode (Counter Electrode)

Next, an ITO film having a film thickness of about 100 nm is formed all over the surface by a sputtering method, thereby forming a transparent counter electrode. The surface resistivity is about 90 Ω/square.

### Step of Forming Second Through Hole, Insulating Layer, and Third Through Hole Having Smaller Size

Next, a second through hole 12b having a size of 150 μm square is formed at the position illustrated in FIG. 20 by scanning the optical axis of a laser processing machine (Nd:YAG laser having a wavelength of 266 nm, a pulse width of 11 nanoseconds, and a strength of 12 mW). After several times of the scanning, the pixel electrode of TFT is exposed. The exposed area of the pixel electrode of TFT is about 120 μm square. Thus, a second through hole having a taper angle is formed.

A dispersion liquid of fine silica particles having an average primary particle diameter of 20 nm (including 13% by weight of solid contents of silica, 2% by weight of a polyvinyl alcohol resin (PVA 500), and 85% by weight of 2,2,3,3-tetrafluoropropanol) is applied by a spin coating method, and subjected to an annealing treatment for 10 minutes with a hot plate at 120° C. Thus, a porous insulating layer having a thickness of about 1 μm is formed. Further, a dispersion liquid of silica particles having an average particle diameter of 450 nm (including about 1% by weight of solid silica contents and 99% by weight of 2-propanol) is applied by a spin coating method.

Next, a third through hole 12c having a size of 80 nm square is formed at the position illustrated in FIG. 20 by scanning the optical axis of a laser processing machine (Nd:YAG laser having a wavelength of 266 nm, a pulse width of 11 nanoseconds, and a strength of 12 mW). After several times of the scanning, the pixel electrode of TFT is exposed. The exposed area of the pixel electrode of TFT is about 60 μm square. Thus, a third through hole having a taper angle is formed.

### Step of Forming First Electrode (Pixel Electrode I; Display Electrode I) and First Electrochromic Layer

An ITO transparent conductive film having a film thickness of about 100 nm is formed all over the surface by a sputtering method. After emission of ultrasonic waves for 3 minutes in 2-propanol, the above-dispersed silica particles having a particle diameter of 450 nm are removed. Thus, a first display electrode having fine through holes is formed.

A titanium oxide fine particle dispersion liquid (SP210 available from Showa Titanium Co., Ltd.) is applied thereon by a spin coating method and subjected to an annealing treatment at 120° C. for 15 minutes. Thus, a titanium oxide particle film is formed. Further, 1% by weight 2,2,3,3-tetrafluoropropanol solution of an electrochromic compound that is a viologen derivative compound that develops yellow color is applied thereon by a spin coating method, and subjected to an annealing treatment at 120° C. for 10 minutes. Thus, a first electrochromic layer composed of the titanium oxide particles and the electrochromic compound is formed.

### Step of Forming Fourth Through Hole, Insulating Layer, and Fifth Through Hole Having Smaller Size

Next, a fourth through hole 12d having a size of 150 μm square is formed at the position illustrated in FIG. 20 by scanning the optical axis of a laser processing machine (Nd:YAG laser having a wavelength of 266 nm, a pulse width of 11 nanoseconds, and a strength of 12 mW). After several times of the scanning, the pixel electrode of TFT is exposed. The exposed area of the pixel electrode of TFT is about 80 μm square. Thus, a fourth through hole having a taper angle is formed.

A dispersion liquid of fine silica particles having an average primary particle diameter of 20 nm (including 13% by weight of solid contents of silica, 2% by weight of a polyvinyl alcohol resin (PVA 500), and 85% by weight of 2,2,3,3-tetrafluoropropanol) is applied by a spin coating method, and subjected to an annealing treatment for 10 minutes with a hot plate at 120° C. Thus, a porous insulating layer having a thickness of about 1 μm is formed. Further, a dispersion liquid of silica particles having an average particle diameter of 450 nm (including about 1% by weight of solid silica contents and 99% by weight of 2-propanol) is applied by a spin coating method.

Next, a fifth through hole 12e having a size of 80 nm square is formed at the position illustrated in FIG. 20 by scanning the optical axis of a laser processing machine (Nd:YAG laser having a wavelength of 266 nm, a pulse width of 11 nanoseconds, and a strength of 12 mW). After several times of the scanning, the pixel electrode of TFT is exposed. The exposed area of the pixel electrode of TFT is about 40 μm square. Thus, a fifth through hole having a taper angle is formed.

### Step of Forming Second Display Electrode (Pixel Electrode II) and Second Electrochromic Layer

An ITO transparent conductive film having a film thickness of about 100 nm is formed all over the surface by a sputtering method. After emission of ultrasonic waves for 3 minutes in 2-propanol, the above-dispersed silica particles having a particle diameter of 450 nm are removed. Thus, a second display electrode having fine through holes is formed.

A titanium oxide fine particle dispersion liquid (SP210 available from Showa Titanium Co., Ltd.) is applied thereon by a spin coating method and subjected to an annealing treatment at 120° C. for 15 minutes. Thus, a titanium oxide particle film is formed. Further, 1% by weight 2,2,3,3-tetrafluoropropanol solution of an electrochromic compound that is a viologen derivative compound that develops magenta color is applied thereon by a spin coating method, and subjected to an annealing treatment at 120° C. for 10 minutes. Thus, a second electrochromic layer composed of the titanium oxide particles and the electrochromic compound is formed.

Step of Dividing into Pixels

The optical axis of a laser processing machine (Nd:YAG laser having a wavelength of 266 nm, a pulse width of 11 nanoseconds, and a strength of 12 mW) is scanned along dotted lines shown in FIG. 20. After several times of the scanning, grooves having a width of about 60 μm are formed. It is confirmed by a white-color interference film thickness meter that the grooves are formed on the flattening layer with a certain amount of depth.

Step of Filling with Electrolyte and Forming Protective Layer

An electrolyte substance tetrabutylammonium perchlorate is dissolved in butylene carbonate to have a concentration of 0.5 M. After adding an UV-curable adhesive (PTC10 available from Jujo Chemical Co., Ltd.) in an amount of 30% by weight thereto, the electrolyte is dropped on the drive substrate. The drive substrate is superimposed on the glass substrate (to the surface of which the first electrode is provided) and irradiated with ultraviolet ray. Thus, an electrochromic display device is prepared. The electrochromic display device has a white color reflectance of about 40%.

The first electrode (counter electrode) is composed of an ITO film having a film thickness of about 100 nm formed by a sputtering method. The surface resistivity is about 90 Ω/square.

Step of Sticking Substrates and Filling with Electrolyte

An electrolyte substance tetrabutylammonium perchlorate is dissolved in butylene carbonate to have a concentration of 0.5 M. After adding an UV-curable adhesive (PTC10 available from Jujo Chemical Co., Ltd.) in an amount of 30% by weight thereto, the electrolyte is dropped on the drive substrate. The drive substrate is superimposed on the glass substrate and irradiated with ultraviolet ray. Thus, an electrochromic display device is prepared. The electrochromic display device has a white color reflectance of about 40%.

### Color Development Test

The above-prepared electrochromic display device is connected to a TFT driver equipped with FPGA and a personal computer, and subjected to a color development test.

The TFT is operated so that an 8.9-mm-square region develops magenta color, by applying a voltage to the counter electrode corresponding to the region and the second display electrode. It takes about 0.7 seconds to achieve magenta color development in that region. Further, the TFT is operated so that another 8.9-mm-square region which is partially overlapped with the above 8.9-mm-square region develops yellow color, by applying a voltage to the counter electrode and the first display electrode. It takes about 0.5 seconds to achieve yellow color development in that region. In the overlapped region, red color development is achieved.

Accordingly, an electrochromic display device for full-color display which prevents the occurrence of color blur between pixels is provided by using a single drive substrate. Display image retention performance is also excellent.

### Comparative Example 4

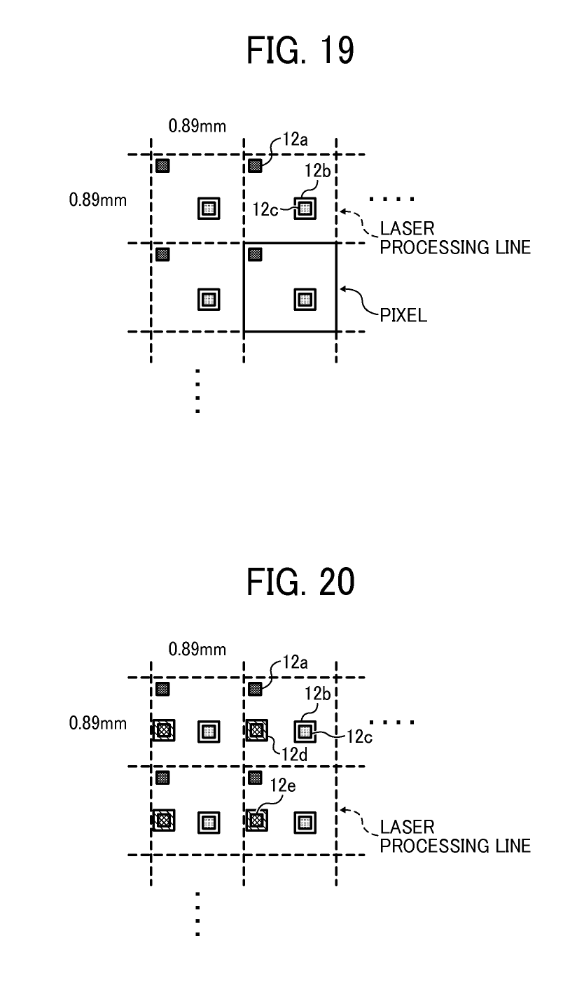

Preparation of 3.5-inch Monolayer Panel An electrochromic display device having a configuration illustrated in FIG. 21, including a display substrate, a display electrode, an electrochromic layer, a white reflective layer, and a drive substrate (counter substrate), is prepared.

In FIG. 21, a numeral 400 denotes an electrochromic display device, a numeral 401 denotes a drive substrate, a numeral 402 denotes a pixel electrode, a numeral 403 denotes a white reflective layer, a numeral 404 denotes an electrolyte layer, a numeral 405 denotes an electrochromic layer, a numeral 406 denotes a display electrode, and a numeral 407 denotes a display substrate.

A 3.5-inch low-temperature polysilicon TFT having QVGA size is used as the drive substrate in the same manner as Example 1. Each pixel has a size of 223.6 μm×223.6 μm.

### Formation of Display Electrode and Electrochromic Layer

On a glass substrate having a size of 90 mm×90 mm serving as the display substrate, an ITO film having a thickness of about 100 nm is formed by a sputtering method with metal masks on a region having a size of 75 mm×60 mm and a drawing portion. Thus, a display electrode is formed. A titanium oxide fine particle dispersion liquid (SP210 available from Showa Titanium Co., Ltd.) is applied thereon by a spin coating method and subjected to an annealing treatment at 120° C. for 15 minutes. Thus, a titanium oxide particle film is formed. Further, 1% by weight 2,2,3,3-tetrafluoropropanol solution of an electrochromic compound that is a viologen compound that develops magenta color is applied thereon by a spin coating method, and subjected to an annealing treatment at 120° C. for 10 minutes. Thus, an electrochromic layer composed of the titanium oxide particles and the electrochromic compound is formed.

### Preparation of Electrochromic Display Device

An electrolyte is prepared by mixing tetrabutylammonium perchlorate serving as an electrolyte substance, dimethylsulfoxide and polyethylene glycol (having a molecular weight of 200) serving as solvents, and an UV-curable adhesive (PTC10 available from Jujo Chemical Co., Ltd.), at a mixing ratio of 1.2:5.4:6:16, and adding white titanium oxide particles (CR50 available from Ishihara Sangyo Kaisha, Ltd., having an average particle diameter of about 250 nm) in an amount of 20% by weight to the mixed solution. After dropping the electrolyte on the drive substrate, the drive substrate is superimposed on the display substrate and irradiated with ultraviolet ray from the drive substrate (counter substrate) side so that the substrates are stuck together by curing. Thus, an electrochromic display device of Comparative Example 4 is prepared. The thickness of the electrolyte layer is adjusted to 10 μm by mixing a bead spacer in an amount of 0.2% by weight in the electrolyte layer. The electrochromic display device has a white color reflectance of 55%. A pixel electrode is provided to the drive substrate.

### Color Development Test

The above-prepared electrochromic display device is connected to a TFT driver equipped with FPGA and a personal computer, and subjected to a color development test.

The TFT is operated so that an 8.9-mm-square region develops color, by applying a voltage to between the display electrode and the pixel electrode corresponding to the region. It takes about 1.2 seconds to achieve magenta color development in that region. Further, the TFT is operated so that another 8.9-mm-square region which is partially overlapped with the above 8.9-mm-square region develops color. It takes about 0.5 seconds to achieve magenta color development in that region. In the overlapped region, deep magenta color development is achieved. After leaving the electrochromic display device for 20 minutes as it stands, display image stability is evaluated. After 60 minutes, color development is observed in the adjacent pixels and display image is deteriorated due to the occurrence of blur.

Accordingly, the electrochromic display device of Example 4 is superior to that of Comparative Example 4 in terms of response speed as well as improvement in display image blur.

### Comparative Example 5

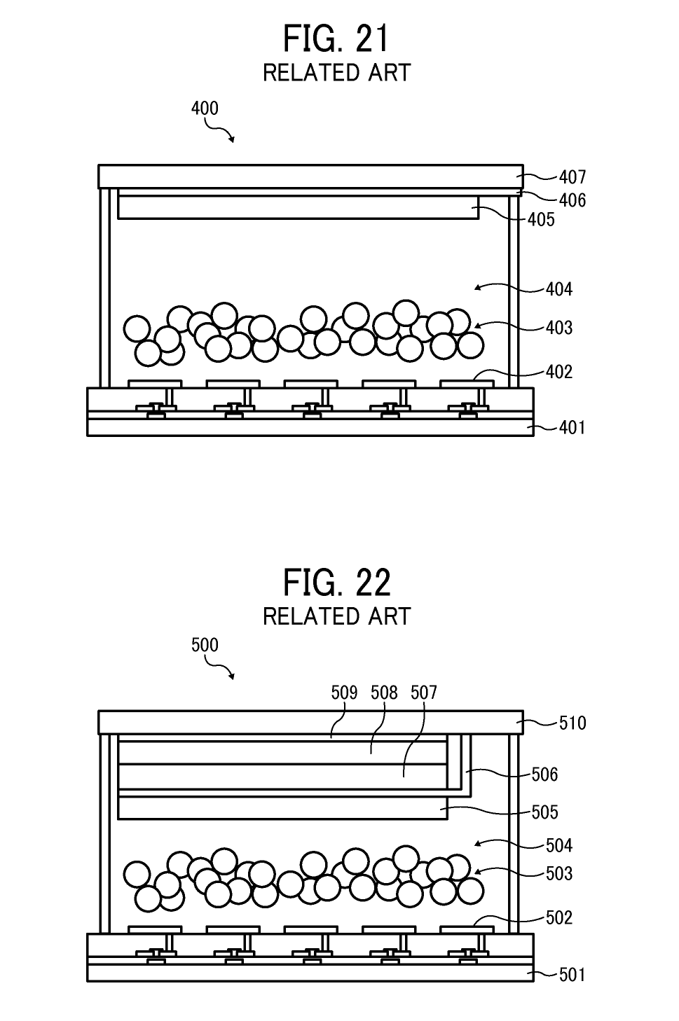

Preparation of 3.5-inch Multilayer Panel An electrochromic display device having a configuration illustrated in FIG. 22, including a display substrate, a first display electrode, a first electrochromic layer, an insulating layer, a second display electrode, a second electrochromic layer, a white reflective layer, a counter electrode (pixel electrode), and a drive substrate (counter substrate), is prepared.

In FIG. 22, a numeral 500 denotes an electrochromic display device, a numeral 501 denotes a drive substrate, a numeral 502 denotes a pixel electrode, a numeral 503 denotes a white reflective layer, a numeral 504 denotes an electrolyte layer, a numeral 505 denotes a second electrochromic layer, a numeral 506 denotes a second display electrode, a numeral 507 denotes an insulating layer, a numeral 508 denotes a first electrochromic layer, a numeral 509 denotes a first display electrode, and a numeral 510 denotes a display substrate.

A 3.5-inch low-temperature polysilicon TFT having QVGA size is used as the drive substrate in the same manner as Example 1. Each pixel has a size of 223.6 μm×223.6 μm. Formation of First Display Electrode and First Electrochromic Layer

On a glass substrate having a size of 90 mm×90 mm serving as the display substrate, an ITO film having a thickness of about 100 nm is formed by a sputtering method with metal masks on a region having a size of 75 mm×60 mm and a drawing portion. Thus, a first display electrode is formed. A titanium oxide fine particle dispersion liquid (SP210 available from Showa Titanium Co., Ltd.) is applied thereon by a spin coating method and subjected to an annealing treatment at 120° C. for 15 minutes. Thus, a titanium oxide particle film is formed. Further, 1% by weight 2,2,3,3-tetrafluoropropanol solution of an electrochromic compound that is a viologen compound that develops magenta color is applied thereon by a spin coating method, and subjected to an annealing treatment at 120° C. for 10 minutes. Thus, a first electrochromic layer composed of the titanium oxide particles and the electrochromic compound is formed.

### Formation of Insulating Layer

A dispersion liquid of fine silica particles having an average primary particle diameter of 20 nm (including 13% by weight of solid contents of silica, 2% by weight of a polyvinyl alcohol resin (PVA 500), and 85% by weight of 2,2,3,3-tetrafluoropropanol) is applied by a spin coating method, and subjected to an annealing treatment for 10 minutes with a hot plate at 120° C. Thus, a porous insulating layer having a thickness of about 1 μm is formed. Further, a dispersion liquid of silica particles having an average particle diameter of 450 nm (including about 1% by weight of solid silica contents and 99% by weight of 2-propanol) is applied by a spin coating method.

### Formation of Second Display Electrode and Second Electrochromic Layer

An ITO film having a thickness of about 100 nm is formed by a sputtering method with metal masks on a region having a size of 75 mm×60 mm and another drawing portion different from that for the first display electrode. After emission of ultrasonic waves for 3 minutes in 2-propanol, the above-dispersed silica particles having a particle diameter of 450 nm are removed. Thus, a second display electrode having fine through holes is formed.

A titanium oxide fine particle dispersion liquid (SP210 available from Showa Titanium Co., Ltd.) is applied thereon by a spin coating method and subjected to an annealing treatment at 120° C. for 15 minutes. Thus, a titanium oxide particle film is formed. Further, 1% by weight 2,2,3,3-tetrafluoropropanol solution of an electrochromic compound that is a viologen derivative compound that develops yellow color is applied thereon by a spin coating method, and subjected to an annealing treatment at 120° C. for 10 minutes. Thus, a second electrochromic layer composed of the titanium oxide particles and the electrochromic compound is formed.

### Preparation of Electrochromic Display Device

An electrolyte is prepared by mixing tetrabutylammonium perchlorate serving as an electrolyte substance, dimethylsulfoxide and polyethylene glycol (having a molecular weight of 200) serving as solvents, and an UV-curable adhesive (PTC10 available from Jujo Chemical Co., Ltd.), at a mixing ratio of 1.2:5.4:6:16, and adding white titanium oxide particles (CR50 available from Ishihara Sangyo Kaisha, Ltd., having an average particle diameter of about 250 nm) in an amount of 20% by weight to the mixed solution. After dropping the electrolyte on the drive substrate, the drive substrate is superimposed on the display substrate and irradiated with ultraviolet ray from the drive substrate (counter substrate) side so that the substrates are stuck together by curing. Thus, an electrochromic display device of Comparative Example 5 is prepared. The thickness of the electrolyte layer is adjusted to 10 μm by mixing a bead spacer in an amount of 0.2% by weight in the electrolyte layer. The electrochromic display device has a white color reflectance of 53%.

### Color Development Test

The above-prepared electrochromic display device is connected to a TFT driver equipped with FPGA and a personal computer, and subjected to a color development test.

The TFT is operated so that an 8.9-mm-square region develops magenta color, by applying a voltage to the pixel electrode corresponding to the region and the display electrode. It takes about 1.5 seconds to achieve magenta color development in that region. Further, the TFT is operated so that another 8.9-mm-square region which is partially overlapped with the above 8.9-mm-square region develops yellow color. It takes about 0.7 seconds to achieve yellow color development in that region. In the overlapped region, red color development is achieved.

Accordingly, the electrochromic display device of Example 5 is superior to that of Comparative Example 5 in terms of response speed. The reason is considered that the electrochromic display device of Comparative Example 5 can solve the problem of deterioration in responsiveness caused by voltage drop due to surface resistance of the display electrode, in accordance with the distance from the electrode drawing pad.

### Example 6

A color development driving test is conducted using the electrochromic display device prepared in Example 5.

The TFT is operated so that an 8.9-mm-square region develops magenta color, by grounding the counter electrode corresponding to the pixel region and applying a negative voltage to the second display electrode. It takes about 0.5 seconds to achieve magenta color development.

Next, the TFT is operated so that another 8.9-mm-square region develops red color, by grounding the counter electrode corresponding to the pixel region and applying a same negative voltage to the first display electrode and the second display electrode. It takes about 1.7 seconds to achieve red color development in that region.

Next, the TFT is operated so that another 8.9-mm-square region develops yellow color, by grounding the counter electrode corresponding to the pixel region and applying a negative voltage to the first display electrode. It takes about 0.5 seconds to achieve yellow color development.

Accordingly, an electrochromic display device for full-color display which prevents the occurrence of color blur between pixels is provided by using a single drive substrate. Display image retention performance is also excellent.

### Comparative Example 6

A color development driving test is conducted using the electrochromic display device prepared in Comparative Example 5.

The TFT is operated so that an 8.9-mm-square region develops magenta color, by grounding the first electrode and applying a positive voltage to the corresponding pixel electrode of TFT. It takes about 1.5 seconds to achieve magenta color development in that region.

Next, the TFT is operated so that another 8.9-mm-square region develops red color, by grounding the first and second display electrodes and applying a positive voltage to the corresponding pixel electrode of TFT. It takes about 4 seconds to achieve red color development in that region.

Next, the TFT is operated so that another 8.9-mm-square region develops yellow color, by grounding the second display electrode and applying a positive voltage to the corresponding pixel electrode of TFT.

The test results show that Example 6 is superior to Comparative Example 6 in terms of responsiveness in multiple color development.

Accordingly, an electrochromic display device for full-color display which prevents the occurrence of color blur between pixels is provided by using a single drive substrate. Display image retention performance is also excellent.

### Example 7

A color development driving test is conducted using the electrochromic display device prepared in Example 5.

The TFT is operated so that an 8.9-mm-square region develops magenta color, by applying a voltage to the counter electrode corresponding to the region and the second display electrode. It takes about 0.7 seconds to achieve magenta color development in that region. Next, the TFT is operated so that the same region develops yellow color and discharges magenta color, by applying a negative voltage to the first display electrode and grounding the second display electrode. It takes about 0.5 seconds to achieve magenta color discharge and yellow color development in that region.

### Comparative Example 7

A color development driving test is conducted using the electrochromic display device prepared in Comparative Example 5.

The TFT is operated so that an 8.9-mm-square region develops magenta color, by applying a voltage to the counter electrode corresponding to the region and the display electrode. It takes about 1.5 seconds to achieve magenta color development in that region. Next, a voltage is applied to between the first display electrode and the second display electrode so that the same region develops yellow color and discharges magenta color. As a result, the region where magenta color has been developed discharges color and the region where magenta color has not been developed develops yellow color.

### Example 8

A display image retaining test is conducted using the electrochromic display device prepared in Example 5.

The TFT is operated so that an 8.9-mm-square region develops magenta color, another 8.9-mm-square region develops yellow color, and yet another 8.9-mm-square region develops red color, by applying a voltage to the counter electrode corresponding to each region, the first display electrode, and the second display electrode. It takes about 1.5 seconds to achieve yellow, magenta, or red color development in each region. Thereafter, each TFT is put into operation intermittently to evaluate image retaining property. As a result, even when the cycle for operating TFT is one hour, the displayed image is of equivalent quality to the initial image.

### Comparative Example 8

A display image retaining test is conducted using the electrochromic display device prepared in Comparative Example 5.

The TFT is operated so that two 8.9-mm-square regions develop magenta color, by grounding the first electrode and applying a positive voltage to the corresponding pixel electrode. Next, the TFT is operated so that one of the 8.9-mm-square regions and another 8.9-mm-square region develop yellow color, by grounding the second display electrode and applying a positive voltage to the corresponding pixel electrode. It takes about 4 seconds to achieve yellow, magenta, or red color development in each region. Thereafter, intermittently, the first display electrode is grounded and a voltage of −0.1 V is applied to the second display electrode. As a result, the displayed image starts to discharge its color after a lapse of about 10 minutes and all the color is discharged after a lapse of 1 hour.

The reason is considered that, in Comparative Example 8, color development density is attenuated because only the potential difference between the display electrodes is maintained, while in Example 8, color development density is not attenuated because each pixel is driven to develop color.

An electrochromic display device according to some embodiments of the present invention is capable of displaying full-color image by using a single drive substrate while preventing the occurrence of color blur between pixels.

In accordance with some embodiments of the present invention, the white reflective layer can be thinned as much as possible owing to the provision of the reflective layer (mirror electrode). In addition, because the reflective layer (mirror electrode) and the white reflective layer are provided on the drive substrate, no white reflective layer is located between the first and second electrodes (i.e., between the effective electrodes). Thus, a full-color electrochromic display device which provides excellent responsiveness and resolution can be provided. In accordance with some embodiments of the present invention, a method of producing the electrochromic display device with simple processes and a driving method of the electrochromic display device which enhances display image retaining property are also provided.

Full-color display is achieved by superimposing three subtractive primary colors of yellow, cyan, and magenta, as described above. In the electrochromic display device according to some embodiments of the present invention, multiple electrochromic layers each developing different colors are stacked, and each electrochromic layer is electronically connected to a drive circuit in a drive substrate (applicable to both active matrix substrates and passive matrix substrates) to achieve full-color display.

What is claimed is:

1. An electrochromic display device, comprising:
a first substrate;
a first electrode formed of a transparent conductive film, overlying the first substrate;
a second electrode formed of a transparent conductive film, overlying the first electrode;
a white reflective layer, overlying the second electrode;
a reflective layer, overlying the white reflective layer;
a support substrate, overlying the reflective layer;
an electrochromic layer, adjacent to the first electrode or the second electrode; and
an electrolyte, present between the first electrode and the second electrode.

2. The electrochromic display device according to claim 1,
wherein each of the first electrode, the second electrode, and the reflective layer is divided,
wherein the second electrode is divided so as to orthogonally intersect with the first electrode or into pixels, and
wherein the first electrode and the reflective layer orthogonally intersect with each other so as to form a matrix.

3. The electrochromic display device according to claim 1, wherein the support substrate is a drive substrate having a thin-film transistor drive circuit.

4. The electrochromic display device according to claim 1, further comprising:
a flattening film disposed between the second electrode and the white reflective layer.

5. The electrochromic display device according to claim 1, further comprising:
a porous insulating layer disposed between the first electrode and the second electrode.

6. The electrochromic display device according to claim 1, further comprising:
one or more pairs of a pixel electrode formed of a transparent conductive film and an electrochromic layer adjacent to the pixel electrode, stacked between the first electrode and the second electrode via an insulating layer.

7. The electrochromic display device according to claim 1, wherein all films disposed between the first electrode or the electrochromic layer, whichever is closest to the first substrate, and the second electrode or the electrochromic layer, whichever is closest to the support substrate, including the transparent conductive films forming the first and second electrodes, are each formed of a porous film having ion-permeable through holes.

8. The electrochromic display device according to claim 1, wherein the electrochromic layer includes:
a porous electrode formed of a transparent conductive film having ion-permeable fine through holes; and
electrochromic molecules modifying a surface of the porous electrode.

9. The electrochromic display device according to claim 1, further comprising:
a second electrochromic layer adjacent to the second electrode,
wherein the electrochromic layer is a first electrochromic layer adjacent to the first electrode,
wherein the first electrochromic layer develops a color upon an oxidation-reduction reaction, and the second electrode develops a complementary color of the color developed in the first electrochromic layer upon a reverse reaction of the oxidation-reduction reaction.

10. The electrochromic display device according to claim 1,
wherein the first electrode or the second electrode is composed of pixel electrodes arranged in a matrix, and
wherein each pair of the pixel electrode and the electrochromic layer adjacent to the pixel electrode is set apart.

11. A method of producing an electrochromic display device, comprising:
1) forming a flattening layer on a drive substrate, and forming a through hole;
2) forming a reflective layer serving as a mirror electrode on the flattening layer;
3) forming a white reflective layer on the reflective layer, forming a flattening film on the white reflective layer, and forming a through hole;
4) forming a pair of a second electrode, formed of a transparent film, and an optional electrochromic layer adjacent to the second electrode on the flattening film;
5) optionally forming a pair of a pixel electrode and an electrochromic layer adjacent to the pixel electrode between the second electrode and a first electrode, formed of a transparent film, via a porous insulating layer, and forming a through hole;
6) forming the first electrode on the pair of the second or pixel electrode and the electrochromic layer adjacent thereto via a porous insulating layer, or on a pair of a first substrate and an optional electrochromic layer adjacent to the first substrate;
7) dividing into pixels; and
8) sticking the drive substrate having the layers formed in the steps 1) to 6) thereon and the first substrate optionally having the layers formed in the step 6) thereon together while filling the layers disposed therebetween with an electrolyte.

12. The electrochromic display device according to claim 1,
wherein the support substrate is a drive substrate having a plurality of drive circuits composing sub pixels,
wherein at least one of the sub pixel is connected to a counter electrode composed of the first electrode or the second electrode via the reflective layer serving as a mirror electrode, and each of the other sub pixels is connected to one of display electrodes composed of the first electrode, the second electrode, or a pixel electrode via the reflective layer serving as a mirror electrode.

13. A method of driving the electrochromic display device according to claim 12, comprising:
applying a voltage between the sub pixel connected to the counter electrode and at least one of the sub pixels connected to the display electrode.
